(19) United States
(12) Patent Application Publication
(10) Pub. No.: US 2024/0380875 A1
(43) Pub. Date: Nov. 14, 2024

(54) WEARABLE ELECTRONIC DEVICE THAT TRACKS GAZE AND FACE

(71) Applicant: Samsung Electronics Co., Ltd., Suwon-si (KR)

(72) Inventors: Jisu RYU, Suwon-si (KR); Jinki KIM, Suwon-si (KR); Myounggyo SEO, Suwon-si (KR); Changrim YU, Suwon-si (KR); Jina JEON, Suwon-si (KR)

(21) Appl. No.: 18/643,364

(22) Filed: Apr. 23, 2024

Related U.S. Application Data
(63) Continuation of application No. PCT/KR2024/095570, filed on Mar. 15, 2024.

(30) Foreign Application Priority Data
May 12, 2023 (KR) 10-2023-0061983
Jul. 24, 2023 (KR) 10-2023-0096300

(51) Int. Cl. H04N 13/366; G06V 40/16; H04N 13/243; H04N 13/296; H04N 23/16; H04N 23/72; H04N 23/73; H04N 23/74; H04N 23/90

(52) U.S. Cl. CPC H04N 13/366; G06V 40/174; H04N 13/243; H04N 13/296; H04N 23/16; H04N 23/72; H04N 23/73; H04N 23/74; H04N 23/90

(57) ABSTRACT

A wearable electronic device is provided. The wearable electronic device includes a processor and memory communicatively coupled to the processor. The wearable electronic device includes a first tracking device including first lights corresponding to a first area of a user wearing the wearable electronic device and first cameras corresponding to the first area, and a second tracking device including second lights corresponding to a second area of the user and second cameras corresponding to the second area. The memory store one or more computer programs including computer-executable instructions that, when executed by the processor, cause the wearable electronic device to generate a first signal related to the exposure of a first primary camera among the first cameras before an exposure time of the first primary camera and input the generated first signal as a signal notifying the second cameras of the start of a frame.

### CROSS-REFERENCE TO RELATED APPLICATION(S)

This application is a continuation application, claiming priority under § 365 (c), of an International application No. PCT/KR2024/095570, filed on Mar. 15, 2024, which is based on and claims the benefit of a Korean patent application number 10-2023-0061983, filed on May 12, 2023, in the Korean Intellectual Property Office, and of a Korean patent application number 10-2023-0096300, filed on Jul. 24, 2023, in the Korean Intellectual Property Office, the disclosures of each of which is incorporated by reference herein in its entirety.

### BACKGROUND

### 1. Field

The disclosure relates to a wearable electronic device that tracks a gaze and a face.

### 2. Description of Related Art

Various wearable electronic devices, such as virtual reality (VR), augmented reality (AR), and/or mixed reality (MR) devices are in commercial use. Among them, some wearable electronic devices, such as a head-mounted display (HMD), which are worn around the head or eyes of a user, may be provided in the form of eyeglasses or goggles including external lenses that view objects nearby or capture images of facing targets.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device that tracks gaze and face.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes one or more processors, memory storing instructions to be executed by the one or more processors, a first tracking device including first lights corresponding to a first area of a user wearing the wearable electronic device and first cameras corresponding to the first area, and a second tracking device including second lights corresponding to a second area of the user and second cameras corresponding to the second area, wherein the memory store one or more computer programs including computer-executable instructions that, when executed by the one or more processors, cause the wearable electronic device to input a first signal related to exposure of a first primary camera among the first cameras, as a signal notifying the second cameras of start of a frame.

In accordance with another aspect of the disclosure, a wearable electronic device is provided. The wearable electronic device includes at least one or more processors, memory communicatively coupled to the one or more processors, a first tracking device including first infrared (IR) lights configured to generate images reflected on a left eye and a right eye of a user wearing the wearable electronic device, a first primary camera configured to track the reflected images and the left eye, and a first secondary camera configured to track the right eye, and a second tracking device including second IR lights configured to reflect light on a face of the user and second secondary cameras configured to recognize a facial expression of the user by the second IR lights, wherein the memory store one or more computer programs including computer-executable instructions that, when executed by the one or more processors, cause the wearable electronic device to generate a first signal related to exposure of the first primary camera at a first exposure time of the first primary camera, and input the first signal as a signal notifying the second secondary cameras of start of a frame.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram showing an electronic device in a network environment according to an embodiment of the disclosure;

FIG. 2 is a perspective view showing an internal configuration of a wearable electronic device according to an embodiment of the disclosure;

FIGS. 3A and 3B are a front view and a rear view of a wearable electronic device according to various embodiments of the disclosure;

FIGS. 4A and 4B are block diagrams showing a wearable electronic device according to various embodiments of the disclosure;

FIG. 5 is a diagram showing arrangement positions of cameras and lights of a first tracking device and a second tracking device in a wearable electronic device according to an embodiment of the disclosure;

FIG. 6 is a diagram showing a temporal relationship between image frames and lights used in a wearable electronic device according to an embodiment of the disclosure;

FIGS. 7A and 7B are diagrams showing an input/output relationship between a primary camera and secondary cameras in a wearable electronic device according to various embodiments of the disclosure;

FIG. 8 is a diagram showing an operation between optical drivers for first lights of a first tracking device and an application processor (AP) in a wearable electronic device according to an embodiment of the disclosure; and

FIG. 9 is a diagram showing an example arrangement of a first tracking device, a second tracking device, and optical drivers in a wearable electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

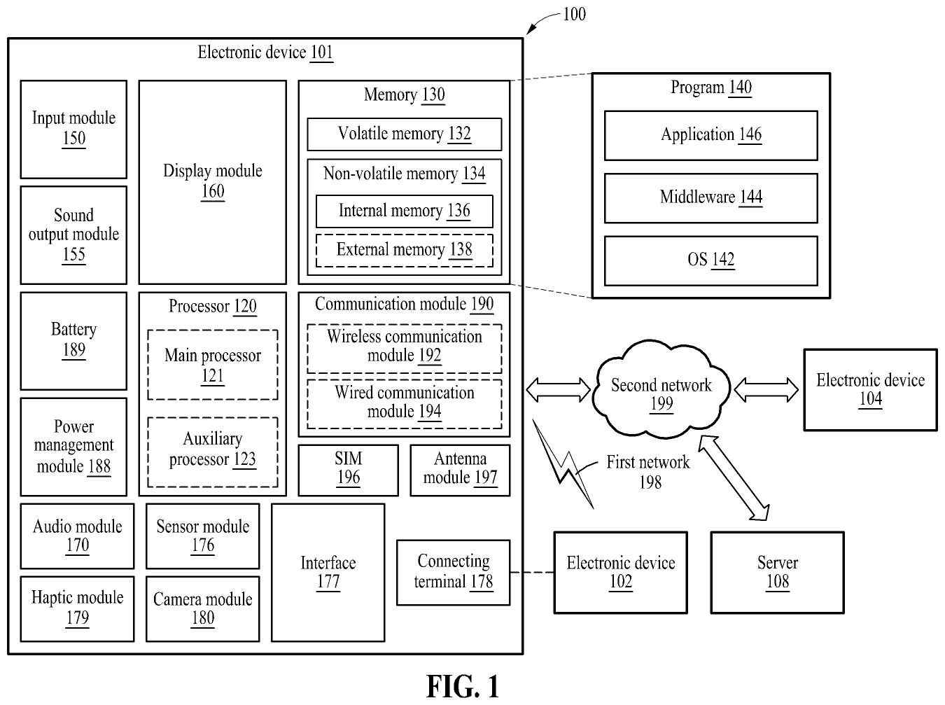

FIG. 1 is a block diagram showing an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or communicate with at least one of an external electronic device 104 and a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in volatile memory 132, process the command or data stored in the volatile memory 132, and store resulting data in non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. Such learning may be performed by, for example, the electronic device 101 in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing records. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry to control a corresponding one of the display, the hologram device, and the projector. According to an embodiment, the display module 160 may include a touch sensor adapted to sense a touch, or a pressure sensor adapted to measure an intensity of a force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the external electronic device 102, such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with an external electronic device (e.g., the external electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and an external electronic device (e.g., the external electronic device 102, the external electronic device 104, or the server 108) and performing communication via the established communication channel. The communication module 190 may include one or more communication processors that are operable independently of the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as, Bluetooth™ wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., an LAN or a wide area network (WAN))). These various types of communication modules may be implemented as a single component (e.g., a single chip), or may be implemented as multiple components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4th generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an antenna array, analog beamforming, or a large-scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to various embodiments, the antenna module 197 may form an mmWave antenna module. According to an embodiment, the mm Wave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., array antennas) disposed on a second surface (e.g., a top or a side surface) of the PCB or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed by the electronic device 101 may be executed at one or more of the external electronic devices 102 and 104, and the server 108. For example, if the electronic device 101 needs to perform a function or a service automatically, or in response to a request from a user or another device, the electronic device 101, instead of, or in addition to, executing the function or the service, may request one or more external electronic devices to perform at least a part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least a part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, each of the external electronic devices 102 and 104 may be a device of the same or different type as or from that of the electronic device 101. According to an embodiment, all or part of the operations performed in the electronic device 101 may be executed in at least one of the external electronic devices 102, 104, and 108. For example, when the electronic device 101 needs to perform a certain function or service automatically or in response to a request from a user or another device, the electronic device 101 may perform the function or service by additionally requesting the at least one external electronic device to perform at least a portion of the function or service, instead of executing the function or service itself. The at least one external electronic device that have received the request may execute at least a portion of the requested function or service, or an additional function or service related to the request, and transmit the result of the execution to the electronic device 101. The electronic device 101 may process the result as is or additionally and provide it as at least part of a response to the request.

For example, the external electronic device 102 may render content data executed in an application and then transmit it to the electronic device 101, and the electronic device 101 that has received the data outputs the content data to the display module 160. When the electronic device 101 detects a user movement through a sensor, the processor 120 of the electronic device 101 may correct the rendered data received from the external electronic device 102 based on movement information and output it to the display module 160. Alternatively, the processor 120 of the electronic device 101 may transmit the movement information to the external electronic device 102 and request rendering such that screen data is updated accordingly. According to an embodiment, the external electronic device 102 may be various types of devices, such as a smartphone or a case device that may store and charge the electronic device 101.

The electronic device described herein according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

Hereinafter, various embodiments will be described using examples where the electronic device 101 is a wearable electronic device, such as a head-mounted display or device (HMD).

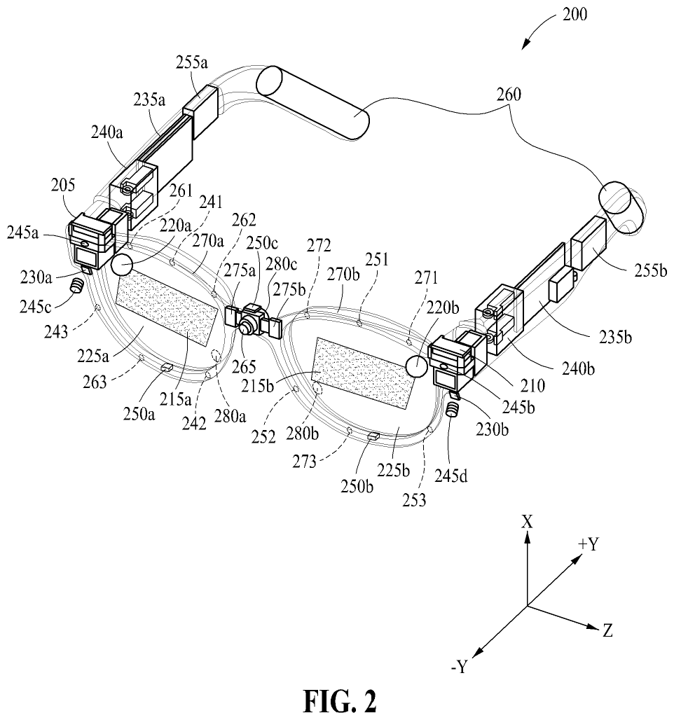

FIG. 2 is a perspective view showing a structure in which an electronic device is implemented in the form of a wearable electronic device according to an embodiment of the disclosure.

Referring to FIG. 2, a wearable electronic device 200 (e.g., the electronic device 101 of FIG. 1) may be worn on a face of a user to provide the user with images associated with an augmented reality (AR) service and/or a virtual reality (VR) service.

In an embodiment, the wearable electronic device 200 may include a first display 205, a second display 210, a first screen display portion 215a, a second screen display portion 215b, a first input optical member 220a, a second input optical member 220b, a first transparent member 225a, a second transparent member 225b, lighting units 230a and 230b, a first printed circuit board (PCB) 235a, a second PCB 235b, a first hinge 240a, a second hinge 240b, first cameras 245a, 245b, 245c, and 245d, a plurality of microphones (e.g., a first microphone 250a, a second microphone 250b, and a third microphone 250c), a plurality of speakers (e.g., a first speaker 255a and a second speaker 255b), a battery 260, second cameras 275a and 275b, a third camera 265, visors 270a and 270b, right-eye light sources 241, 242, 243, 261, 262, and 263, and left-eye light sources 251, 252, 253, 271, 272, and 273.

In an embodiment, a display (e.g., the first display 205 and the second display 210) may include, for example, a liquid crystal display (LCD), a digital mirror device (DMD), a liquid crystal on silicon (LCoS), an organic light-emitting diode (OLED), a micro light-emitting diode (micro-LED), or the like. Although not shown, when the display is one of an LCD, a DMD, and an LCOS, the wearable electronic device 200 may include a light source configured to emit light to a screen output area of the display. In another embodiment, when the display is capable of generating light by itself, for example, when the display is either an OLED or a micro-LED, the wearable electronic device 200 may provide a virtual image with a relatively high quality to the user even though a separate light source is not included. For example, when the display is implemented as an OLED or a micro-LED, a light source may be unnecessary, which may lead to lightening of the wearable electronic device 200. Hereinafter, a display capable of generating light by itself will be referred to as a “self-luminous display,” and the description thereof will be made on the assumption of the self-luminous display.

The display (e.g., the first display 205 and the second display 210) according to various embodiments may include at least one micro-LED. For example, the micro-LED may express red (R), green (G), and blue (B) by emitting light by itself, and a single chip may implement a single pixel (e.g., one of R, G, and B pixels) because the micro-LED is relatively small in size (e.g., 100 μm or less). Accordingly, the display may provide a high resolution without a backlight unit (BLU), when the display is composed of a micro-LED.

However, embodiments are not limited thereto. A single pixel may include R, G, and B, and a single chip may be implemented by a plurality of pixels including R, G, and B pixels.

In an embodiment, the display (e.g., the first display 205 and the second display 210) may include a display area including pixels for displaying a virtual image, and light-receiving pixels (e.g., photo sensor pixels) that receive the light reflected from eyes disposed among pixels, convert the reflected light into electrical energy, and output the electrical energy.

In an embodiment, the wearable electronic device 200 may detect a gaze direction (e.g., a movement of a pupil) of the user through the light-receiving pixels. For example, the wearable electronic device 200 may detect and track a gaze direction of a right eye of the user and a gaze direction of a left eye of the user, via one or more light-receiving pixels of the first display 205 and one or more light-receiving pixels of the second display 210. The wearable electronic device 200 may determine a central position of a virtual image according to the gaze directions (e.g., directions in which pupils of the right eye and the left eye of the user gaze) detected via the one or more light-receiving pixels.

In an embodiment, the right-eye light sources 241, 242, 243, 261, 262, and 263 and the left-eye light sources 251, 252, 253, 271, 272, and 273 that are attached around the frame of the wearable electronic device 200 may be used as an auxiliary means to facilitate the detection of eye gaze when capturing images of the pupils with the second cameras 275a and 275b. When the right-eye light sources 241, 242, 243, 261, 262, and 263 and the left-eye light sources 251, 252, 253, 271, 272, and 273 are used as the auxiliary means to facilitate the detection of eye gaze, they may include LEDs or infrared LEDs (IR LEDs) that generates IR waves.

In an embodiment, light emitted from the display (e.g., the first display 205 and the second display 210) may reach the first screen display portion 215a formed on the first transparent member 225a that faces the right eye of the user, and the second screen display portion 215b formed on the second transparent member 225b that faces the left eye of the user, by passing through a lens (not shown) and a waveguide. For example, the light emitted from the display (e.g., the first display 205 and the second display 210) may be reflected from a grating area formed on an input optical member (e.g., the first input optical member 220a and the second input optical member 220b) and the screen display portions 215a and 215b to be transferred to the eyes of the user, by passing through the waveguide. The first transparent member 225a and/or the second transparent member 225b may be formed as, for example, a glass plate, a plastic plate, or a polymer, and may be transparently or translucently formed.

In an embodiment, the lens (not shown) may be disposed on a front surface of the display (e.g., the first display 205 and the second display 210). The lens (not shown) may include a concave lens and/or a convex lens. For example, the lens (not shown) may include a projection lens or a collimation lens.

In an embodiment, the screen display portions 215a and 215b or a transparent member (e.g., the first transparent member 225a and the second transparent member 225b) may include a lens including a waveguide and a reflective lens.

In an embodiment, the waveguide may be formed of glass, plastic, or a polymer, and may have a nanopattern formed on one surface of the inside or outside thereof, for example, a grating structure of a polygonal or curved shape. According to an embodiment, light incident onto one end of the waveguide may be propagated inside the display waveguide by the nanopattern to be provided to the user. In an embodiment, the waveguide formed as a free-form prism may provide incident light to the user via a reflection mirror. The waveguide may include at least one diffractive element (e.g., a diffractive optical element (DOE) or a holographic optical element (HOE)) or at least one reflective element (e.g., a reflection mirror). In an embodiment, the waveguide may guide light emitted from the display (e.g., the first display 205 and the second display 210) to the eyes of the user, using the at least one diffractive element or reflective element included in the waveguide.

According to various embodiments, the diffractive element may include an input optical member (e.g., 220a and 220b) and/or an output optical member (not shown). For example, the input optical member (e.g., 220a and 220b) may refer to an input grating area, and the output optical member (not shown) may refer to an output grating area. The input grating area may function as an input terminal to diffract (or reflect) light output from the display (e.g., the first display 205 and the second display 210) (e.g., a micro-LED) to transmit the light to a transparent member (e.g., the first transparent member 225a and the second transparent member 225b) of a screen display portion (e.g., the first screen display portion 215a and the second screen display portion 215b). The output grating area may function as an outlet to diffract (or reflect), to the eyes of the user, the light transmitted to the transparent member (e.g., the first transparent member 225a and the second transparent member 225b) of the waveguide.

According to various embodiments, the reflective element may include a total reflection optical element or a total reflection waveguide for total internal reflection (TIR). For example, TIR, which is one of schemes for inducing light, may form an angle of incidence such that light (e.g., a virtual image) input through the input grating area is totally (e.g., 100%) reflected from one surface (e.g., a specific surface) of the waveguide, to completely transmit the light to the output grating area.

In an embodiment, a light path of the light emitted from the display (e.g., the first display 205 and the second display 210) may be guided to the waveguide through the input optical member (e.g., 220a and 220b). The light traveling in the waveguide may be guided toward the eyes of the user through the output optical member. The screen display portions 215a and 215b may be determined based on the light emitted toward the eyes.

In an embodiment, the first cameras 245a, 245b, 245c, and 245d may be used to detect and track the face, head, and/or hands of the user and recognize gestures (e.g., hand gestures) of the user. The first cameras 245a, 245b, 245c, and 245d may be used for three degrees of freedom (3DoF) and six degrees of freedom (6DoF) face or head tracking, hand detection and tracking, and gesture, position (space and environment), and/or movement recognition. For example, the first cameras 245a, 245b, 245c, and 245d may include a global shutter (GS) camera to detect movements of the head or the hands and track the movements. Depending on embodiments, the third camera 265 may be used for hand detection and tracking, and recognition of gestures of the user.

For example, the first cameras 245a, 245b, 245c, and 245d may use a stereo camera for head tracking (including the face) and space recognition, and cameras with the same specification and performance may be applied thereto.

The first cameras 245a, 245b, 245c, and 245d may use a GS camera having desirable performance (e.g., image dragging) to detect fine movements of fingers and quick movements of the hands, and track the movements.

According to various embodiments, the first cameras 245a, 245b, 245c, and 245d may use a rolling shutter (RS) camera. The first cameras 245a, 245b, 245c, and 245d may perform a simultaneous localization and mapping (SLAM) function for 6DoF space recognition and depth imaging. The first cameras 245a, 245b, 245c, and 245d may also perform a user gesture recognition function.

In an embodiment, the second cameras 275a and 275b may image, recognize (detect), and/or track a trajectory of the eyes (e.g., the pupils and iris) or gaze of the user. The second cameras 275a and 275b may periodically or nonperiodically transmit information (e.g., trajectory information) related to the trajectory of the eyes or gaze of the user to a processor (e.g., the processor 120 of FIG. 1). The second cameras 275a and 275b may also capture an image of the outside. The second cameras 275a and 275b may also be referred to as an eye-tracking camera (or shortly “ET camera”). The second cameras 275a and 275b may track a gaze direction of the user. Based on the gaze direction of the user, the wearable electronic device 200 may allow a center of a virtual image projected on the screen display portions 215a and 215b to be disposed according to the gaze direction of the user.

The second cameras 275a and 275b for eye tracking may use a GS camera to detect the pupils and track a quick movement of the pupils. The second cameras 275a and 275b may be installed for the left eye or the right eye, and cameras with the same specification and performance may be used for the second camera 275a for the right eye and the second camera 275b for the left eye.

In an embodiment, the third camera 265 may also be referred to as a “high-resolution (HR)” or a “photo video (PV)” camera and may include an HR camera. The third camera 265 may include a color camera having functions for obtaining a high-quality image, such as, for example, an automatic focus (AF) function and an optical image stabilizer (OIS). However, examples are not limited thereto, and the third camera 265 may include a GS camera or an RS camera.

In an embodiment, the fourth cameras 280a, 280b, and 280c may recognize the face and/or facial expressions of the user. The fourth cameras 280a, 280b, and 280c may also be referred to as a face-tracking camera (or shortly “FT camera”).

In an embodiment, at least one sensor (e.g., a gyro sensor, an acceleration sensor, a geomagnetic sensor, a touch sensor, an illuminance sensor, and/or a gesture sensor) and the first cameras 245a, 245b, 245c, and 245d may perform at least one of the functions among 6DoF head tracking, pose estimation and prediction, gesture and/or space recognition, and SLAM through depth imaging.

In an embodiment, the first cameras 245a, 245b, 245c, and 245d may be used separately as a camera for head tracking including the face and a camera for hand tracking. The first cameras 245a, 245b, 245c, and 245d may not all be necessarily used, but only some of them (e.g., 245a and 245b or 245c and 245d) may be used.

According to an embodiment, at least one of the first cameras 245a, 245b, 245c, and 245d, the second cameras 275a and 275b, and the third camera 265 may be replaced with a sensor module (e.g., a light detection and ranging (LiDAR) sensor). The sensor module may include, for example, at least one of a vertical-cavity surface-emitting laser (VCSEL), an IR sensor, and/or a photodiode.

In an embodiment, the lighting units 230a and 230b may be used differently according to positions in which the light units 230a and 230b are attached. For example, the lighting units 230a and 230b may be attached together with the first cameras 245a, 245b, 245c, and 245d provided around a hinge (e.g., the first hinge 240a and the second hinge 240b) that connects a frame and a temple or around a bridge that connects frames. For example, when a GS camera is used to capture an image, the lighting units 230a and 230b may be used to supplement surrounding brightness. For example, the lighting units 230a and 230b may be used in a dark environment or when it is not easy to detect an object to be captured due to reflected light and a mixture of various light sources.

In an embodiment, a PCB (e.g., the first PCB 235a and the second PCB 235b) may include a processor (e.g., the processor 120 of FIG. 1) configured to control the components of the wearable electronic device 200, memory (e.g., the memory 130 of FIG. 1), and a communication module (e.g., the communication module 190 of FIG. 1).

For example, the communication module may support establishing a direct (e.g., wired) communication channel or wireless communication channel between the wearable electronic device 200 and an external electronic device and performing communication via the established communication channel. The PCB (e.g., the first PCB 235a and the second PCB 235b) may transmit electrical signals to the components included in the wearable electronic device 200.

The communication module (e.g., the communication module 190 of FIG. 1) may include one or more communication processors that are operable independently of the processor and that support direct (e.g., wired) communication or wireless communication. According to an embodiment, the communication module may include a wireless communication module (e.g., a cellular communication module, a short-range wireless communication module, or a GNSS communication module) or a wired communication module (e.g., a LAN communication module or a PLC module). A corresponding one of these communication modules may communicate with the external electronic device via a short-range communication network, such as, Bluetooth™, Wi-Fi direct, or IrDA, or via a long-range communication network, such as, a legacy cellular network, a 5G network, a next-generation communication network, the Internet, or a computer network (e.g., an LAN or a WAN). These various types of communication modules may be implemented as a single component (e.g., a single chip), or may be implemented as multiple components (e.g., multiple chips) separate from each other.

The wireless communication module may support a 5G network after a 4G network, and a next-generation communication technology, e.g., an NR access technology. The NR access technology may support eMBB, mMTC, or URLLC. The wireless communication module 192 may support a high-frequency band (e.g., an mmWave band) to achieve, e.g., a high data transmission rate. The wireless communication module may support various technologies for securing performance on a high-frequency band, such as, e.g., beamforming, massive MIMO, FD-MIMO, an antenna array, analog beamforming, or a large-scale antenna.

The wearable electronic device 200 may further include an antenna module (e.g., the antenna module 197 in FIG. 1). The antenna module may transmit signals or power to or receive signals or power from the outside (e.g., an external electronic device). According to an embodiment, the antenna module may include an antenna including a radiator that is formed of a conductor or a conductive pattern formed on a substratum (e.g., the first PCB 235a and the second PCB 235b). According to an embodiment, the antenna module may include a plurality of antennas (e.g., an antenna array).

In an embodiment, a plurality of microphones (e.g., the first microphone 250a, the second microphone 250b, and the third microphone 250c) may process an external acoustic signal into electrical audio data. The electrical audio data may be variously used according to a function being performed (or an application being executed) by the wearable electronic device 200.

In an embodiment, a plurality of speakers (e.g., the first speaker 255a and the second speaker 255b) (e.g., the sound output module 155 of FIG. 1) may output audio data that is received from the communication module or stored in the memory.

In an embodiment, the battery 260 may be provided as one or more batteries, and may supply power to the components included in the wearable electronic device 200.

In an embodiment, the visors 270a and 270b may adjust a transmittance amount of external light incident on the eyes of the user according to a transmittance. The visors 270a and 270b may be disposed in front or behind the screen display portions 215a and 215b. The front side of the screen display portions 215a and 215b may refer to a direction opposite to the user wearing the wearable electronic device 200, and the rear side thereof may refer to a direction on the user's side of the user wearing the electronic device 200. The visors 270a and 270b may protect the screen display portions 215a and 215b and adjust the transmittance amount of external light.

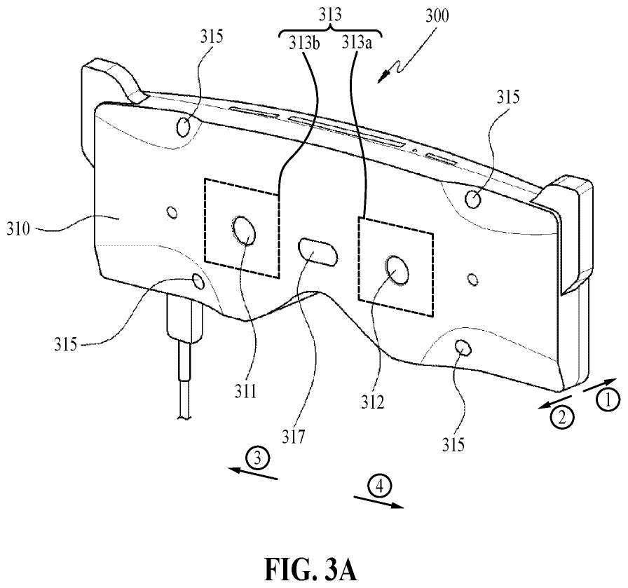

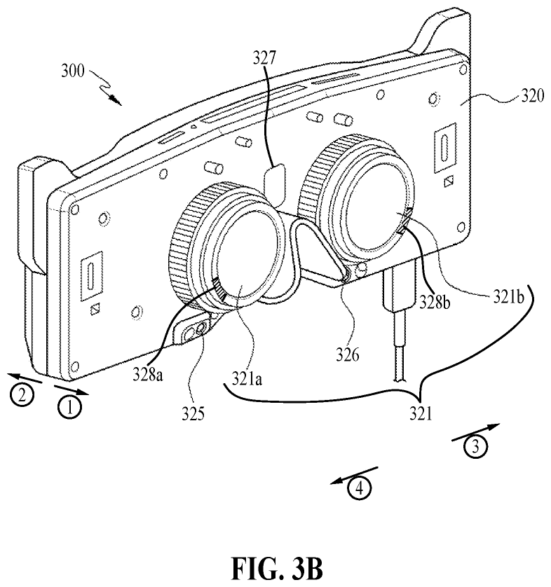

FIGS. 3A and 3B are a front view and a rear view of a wearable electronic device 300 according to various embodiments of the disclosure.

FIG. 3A shows an outward form of the wearable electronic device 300 viewed in a first direction (indicated as (1)), and FIG. 3B shows an outward form of the wearable electronic device 300 viewed in a second direction (indicated as (2). When a user wears the wearable electronic device 300, an outward form viewed by the eyes of the user may be the one shown in FIG. 3B.

Referring to FIG. 3A, according to various embodiments, the electronic device 101 of FIG. 1 may include the wearable electronic device 300 configured to provide a service providing an extended reality (XR) experience to the user. For example, XR or XR service may be defined as a service that collectively refers to VR, AR, and/or MR.

According to an embodiment, the wearable electronic device 300 may be a head-mounted device or display (HMD) worn on a head of the user but may be provided in the form of at least one of glasses, goggles, a helmet, or a hat. The wearable electronic device 300 may also include some types, such as an optical see-through (OST) type configured such that, when being worn, external light reaches the eyes of the user through glasses or a video see-through (VST) type configured such that, when being worn, light emitted from a display reaches the eyes of the user but external light is blocked not to reach the eyes of the user.

According to an embodiment, the wearable electronic device 300 may be worn on the head of the user and provide images related to an XR service to the user. For example, the wearable electronic device 300 may provide XR content (hereinafter also referred to as an XR content image) output such that at least one virtual object is visible overlapping in a display area or an area determined as a field of view (FoV) of the user. According to an embodiment, the XR content may refer to an image related to a real space acquired through a camera (e.g., an image-capturing camera) or an image or video in which at least one virtual object is added to a virtual space. According to an embodiment, the wearable electronic device 300 may provide XR content that is based on a function being performed by the wearable electronic device 300 and/or a function being performed by at least one external electronic device (e.g., the external electronic device 102, 104, or 108 of FIG. 1).

According to an embodiment, the wearable electronic device 300 may be at least partially controlled by an external electronic device (e.g., the external electronic device 102 or 104 of FIG. 1), or may perform at least one function under the control of the external electronic device or perform at least one function independently.

Referring to FIG. 3A, on a first surface 310 of a housing of a main body of the wearable electronic device 300, cameras (e.g., second function cameras 311 and 312, first function cameras 315, and/or a depth sensor 317) for acquiring information associated with a surrounding environment of the wearable electronic device 300 may be disposed.

In an embodiment, the second function cameras 311 and 312 may acquire images related to the surrounding environment of the wearable electronic device 300. With the wearable electronic device 300 worn by the user, the first function cameras 315 may acquire images. The first function cameras 315 may be used for hand detection and tracking, and recognition of gestures (e.g., hand gestures) of the user. The first function cameras 315 may be used for 3DoF and 6DoF head tracking, position (space, environment) recognition, and/or movement recognition. In an embodiment, the second function cameras 311 and 312 may also be used for hand detection and tracking, and the recognition of user gestures.

In an embodiment, the depth sensor 317 may be configured to transmit a signal and receive a signal reflected from an object, and may be used to determine a distance to the object based on a time of flight (TOF). Alternatively of or additionally, a first camera (e.g., 245a, 245b, 245c, and 245d) may determine the distance to the object in place of the depth sensor 317.

Referring to FIG. 3B, on a second surface 320 of the housing of the main body, fourth function cameras 325, 326, and 327 (e.g., face recognition cameras) (e.g., the fourth cameras 280a, 280b, and 280c of FIG. 2), and/or a display 321 (and/or lens) may be disposed.

In an embodiment, face recognition cameras (e.g., 325, 326, and 327) adjacent to a display may be used to recognize a face of the user or may recognize and/or track both eyes of the user.

In an embodiment, the display 321 (and/or lens) may be disposed on the second surface 320 of the wearable electronic device 300. In an embodiment, the wearable electronic device 300 may not include some of a plurality of cameras (e.g., 315). Although not shown in FIGS. 3A and 3B, the wearable electronic device 300 may further include at least one of the components shown in FIG. 2.

According to an embodiment, the wearable electronic device 300 may include the main body in which at least some of the components of FIG. 1 is mounted. In a first direction (1) of the main body facing the face of the user, the display 321 (e.g., the display module 160 of FIG. 1), third function cameras 328a and 328b (e.g., eye-tracking cameras (or ET cameras)), the fourth function cameras 325, 326, and 327 (e.g., the face recognition cameras) may be disposed.

In a second direction (2) opposite to the first direction (1) of the main body, the first function cameras 315 (e.g., the recognition cameras), the second function cameras 311 and 312 (e.g., the image-capturing cameras), the depth sensor 317, and a touch sensor 313 may be disposed. Although not shown in the drawings, the main body may include therein memory (e.g., the memory 130 of FIG. 1) and a processor (e.g., the processor 120 of FIG. 1), and may further include other components shown in FIG. 1.

According to an embodiment, the display 321 may include, for example, an LCD, a digital mirror device (DMD), a liquid crystal on silicon (LCoS) device, and an OLED, or a micro-LED.

In an embodiment, when the display 321 is formed with one of an LCD, a DMD, and LCOS, the wearable electronic device 300 may include a light source that emits light to a screen output area of the display 321. In another embodiment, when the display 321 is capable of generating light on its own, for example, when the wearable electronic device 300 is formed with one of an OLED or a micro-LED, the wearable electronic device 300 may provide an XR content image of a desirable quality to the user, even without a separate light source. In an embodiment, when the display 321 is implemented with an OLED or a micro-LED, the wearable electronic device 300 may be lightweight because it does not require a light source.

According to an embodiment, the display 321 may include a first display 321a and/or a second display 321b. The user may use the wearable electronic device 300 with it on their face. The first display 321a and/or the second display 321b may be formed of a glass plate, a plastic plate, or a polymer, and may be formed transparently or translucently. The first display 321a may include a first transparent member, and the second display 321b may include a second transparent member. According to an embodiment, the first display 321a may be disposed to face a right eye of the user in a third direction 33, and the second display 321b may be disposed to face a left eye of the user in a fourth direction 4). According to various embodiments, when the display 321 is transparent, it may be disposed at a position facing the eyes of the user to form a screen display area.

According to an embodiment, the display 321 may include a lens including a transparent waveguide. The lens may serve to adjust the focus such that a screen (e.g., an XR content image) output to the display 321 is to be viewed by the eyes of the user. For example, light emitted from a display panel may pass through the lens and be transmitted to the user through the waveguide formed within the lens. The lens may include, for example, a Fresnel lens, a pancake lens, or a multichannel lens.

An optical waveguide (e.g., waveguide) may serve to transmit a light source generated by a display (e.g., the displays 205 and 210 of FIG. 2) to the eyes of the user. The optical waveguide may be formed of glass, plastic, or polymer, and may include a nanopattern formed on a part of an inner or outer surface, for example, a polygonal or curved grating structure. According to an embodiment, light incident on one end of the optical waveguide, that is, an output image of the display (e.g., the displays 205 and 210 of FIG. 2), may propagate inside the optical waveguide and be provided to the user. In addition, the optical waveguide formed with a free-form prism may provide the incident light to the user through a reflection mirror. The optical waveguide may include at least one of at least one diffractive element (e.g., a DOE and an HOE) or at least one reflective element (e.g., a reflective mirror). The optical waveguide may guide an image output from the display (e.g., the displays 205 and 210 of FIG. 2) to the eyes of the user using the at least one diffractive element or reflective element included in the optical waveguide.

According to an embodiment, the diffractive element may include an input optical member/output optical member (not shown). For example, the input optical member may refer to an input grating area, and the output optical member (not shown) may refer to an output grating area. The input grating area may serve as an input end that diffracts (or reflects) light output from a light source (e.g., a micro-LED) to transmit the light to a transparent member (e.g., the first display 321a and the second display 321b) of the screen display area. The output grating area may serve as an outlet that diffracts (or reflects) the light transmitted to a transparent member (e.g., a first transparent member and a second transparent member) of the optical waveguide to the eyes of the user.

According to an embodiment, the reflective element may include a TIR optical element or a TIR waveguide for TIR. For example, TIR, which is a method of guiding light, may generate an angle of incidence such that light (e.g., a virtual image) input through the input grating area is to be reflected substantially 100% from one surface (e.g., a specific side) of the optical waveguide and the light is to be transmitted substantially 100% up to the output grating area.

In an embodiment, light emitted from the display 321 may be guided to an optical path to the waveguide through the input optical member. The light traveling inside the optical waveguide may be guided toward the eyes of the user through the output optical member. The screen display area may be determined based on the light emitted in the direction of the eyes.

The first function cameras 315 (e.g., the recognition cameras) may be used for a function of detecting a movement of the user or recognizing a gesture of the user. The first function cameras 315 may support at least one of head tracking, hand detection and hand tracking, and space recognition. For example, the first function cameras 315 may mainly use a GS camera having desirable performance compared to an RS camera to detect and track fine gestures or movements of hands and fingers, and may be configured as a stereo camera including two or more GS cameras for head tracking and space recognition. The first function cameras 315 may perform functions, such as, 6DoF space recognition, and a SLAM function for recognizing information (e.g., position and/or direction) associated with a surrounding space through depth imaging.

The second function cameras 311 and 312 (e.g., the image-capturing cameras) may be used to capture images of the outside, generate an image or video corresponding to the outside, and transmit it to a processor (e.g., the processor 120 of FIG. 1). The processor 120 may display the image provided from the second function cameras 311 and 312 on the display 321. The second function cameras 311 and 312 may also be referred to as a high resolution (HR) or photo video (PV) camera and may include an HR camera. For example, the second function cameras 311 and 312 may be color cameras equipped with a function for acquiring high-quality images, such as, an auto focus (AF) function and optical image stabilizer (OIS), but are not limited thereto. The second function cameras 311 and 312 may also include a GS camera or an RS camera.

The third function cameras 328a and 328b (e.g., the eye-tracking cameras) may be displayed on the display 321 (or inside the main body) such that the camera lenses face the eyes of the user when the user wears the wearable electronic device 300. The third function cameras 328a and 328b may be used for detecting the pupils of the eyes and tracking them (i.e., eye tracking or shortly “ET”). The processor 120 may verify a gaze direction by tracking movements of the left eye and the right eye of the user in images received from the third function cameras 328a and 328b. By tracking positions of the pupils in the images, the processor 120 may be configured such that the center of a XR content image displayed on the screen display area is positioned according to the gaze direction in which the pupils are gazing. For example, the third function cameras 328a and 328b may use GS cameras to detect the pupils and track their movements. The third function cameras 328a and 328b may be installed for the left eye and the right eye, respectively, and may have the same performance and specifications.

The fourth function cameras 325, 326, and 327 (e.g., the face recognition cameras) may be used to detect and track a facial expression of the user (i.e., face tracking or shortly “FT”) when the user wears the wearable electronic device 300. According to an embodiment, the wearable electronic device 300 may include a lighting unit (e.g., LED) (not shown) as an auxiliary means for cameras. For example, the third function cameras 328a and 328b may use a lighting unit included in a display as an auxiliary means for facilitating gaze detection when tracking eye movements, to direct emitted light (e.g., IR LED of an IR wavelength) toward both eyes of the user. For another example, the second function cameras 311 and 312 may further include a lighting unit (e.g., a flash) as an auxiliary means for supplementing surrounding brightness when capturing an image of the outside.

According to an embodiment, the depth sensor 137 (or depth camera) may be used to verify a distance to an object (e.g., a target) through, for example, TOF. TOF, which is a method of measuring a distance to an object using a signal (e.g., near-infrared (NIR) rays, ultrasound, or laser), may transmit a signal from a transmitter and then measure the signal by a receiver, and may measure a distance to an object based on a TOF of the signal.

According to an embodiment, the touch sensor 313 may be disposed in the second direction (2) of the main body. For example, when the user wears the wearable electronic device 300, the eyes of the user may view in the first direction (1) of the main body. The touch sensor 313 may be implemented as a single type or a left/right separated type based on the shape of the main body but is not limited thereto. For example, in a case in which the touch sensor 313 is implemented as the left/right separated type as shown in FIG. 3A, when the user wears the wearable electronic device 300, a first touch sensor 313a may be disposed at a position corresponding to the left eye of the user in the fourth direction 4), and a second touch sensor 313b may be disposed at a position corresponding to the right eye of the user in the third direction 3.

The touch sensor 313 may recognize a touch input using at least one of, for example, capacitive, resistive, infrared, or ultrasonic method. For example, the touch sensor 313 using the capacitive method may recognize a physical touch (or contact) input or hovering (or proximity) input of an external object. According to some embodiments, the wearable electronic device 300 may use a proximity sensor (not shown) to recognize the proximity to an external object.

According to an embodiment, the touch sensor 313 may have a two-dimensional (2D) surface and transmit, to the processor 120, touch data (e.g., touch coordinates) of an external object (e.g., a finger of the user) contacting the touch sensor 313. The touch sensor 313 may detect a hovering input of an external object (e.g., a finger of the user) approaching within a first distance away from the touch sensor 313 or detect a touch input contacting the touch sensor 313.

According to an embodiment, when an external object touches the touch sensor 313, the touch sensor 313 may provide 2D information about a contact point as “touch data” to the processor 120, and the touch data may also be described as a “touch mode.” When the external object is positioned within the first distance from the touch sensor 313 (or hovers above a proximity or touch sensor), the touch sensor 313 may provide hovering data about a timing or position of the external object hovering around the touch sensor 313 to the processor 120, and the hovering data may also be described as a “hovering mode/proximity mode.”

According to an embodiment, the wearable electronic device 300 may acquire the hovering data using at least one of the touch sensor 313, a proximity sensor (not shown), or/and the depth sensor 317 to generate information about a distance, position, or time between the touch sensor 313 and an external object.

According to an embodiment, the main body may include the components of FIG. 1, for example, the processor 120 and the memory 130.

The memory 130 may store various instructions that may be executed by the processor 120. The instructions may include control instructions, such as, for example, arithmetic and logical operations, data movement, or input/output, which may be recognized by the processor 120. The memory 130 may include volatile memory (e.g., the volatile memory 132 of FIG. 1) and non-volatile memory (e.g., the non-volatile memory 134 of FIG. 1) to store, temporarily or permanently, various data.

The processor 120 may be operatively, functionally, and/or electrically connected to each of the components of the wearable electronic device 300 to perform control and/or communication-related computation or data processing of each of the components. The operations performed by the processor 120 may be stored in the memory 130 and, when executed, may be executed by the instructions that cause the processor 120 to operate.

Although there will be no limitation to the computation and data processing functions implemented by the processor 120 on the wearable electronic device 300, a series of operations related to an XR content service function will be described hereinafter. The operations of the processor 120 to be described below may be performed by executing the instructions stored in the memory 130.

According to an embodiment, the processor 120 may generate a virtual object based on virtual information that is based on image information. The processor 120 may output a virtual object related to an XR service along with background spatial information through the display 321. For example, the processor 120 may acquire image information by capturing an image related to a real space corresponding to an FoV of the user wearing the wearable electronic device 300 through the second function cameras 311 and 312, or generate a virtual space of a virtual environment. For example, the processor 120 may display, on the display 321, XR content (or also referred to herein as an XR content screen) that outputs at least one virtual object such that it is visible overlapping in a display area or an area determined as the FoV of the user.

According to an embodiment, the wearable electronic device 300 may have a form factor to be worn on the head of the user. The wearable electronic device 300 may further include a strap and/or a wearing member to be fixed on a body part of the user. The wearable electronic device 300 may provide a VR, AR, and/or MR-based user experience while worn on the head of the user.

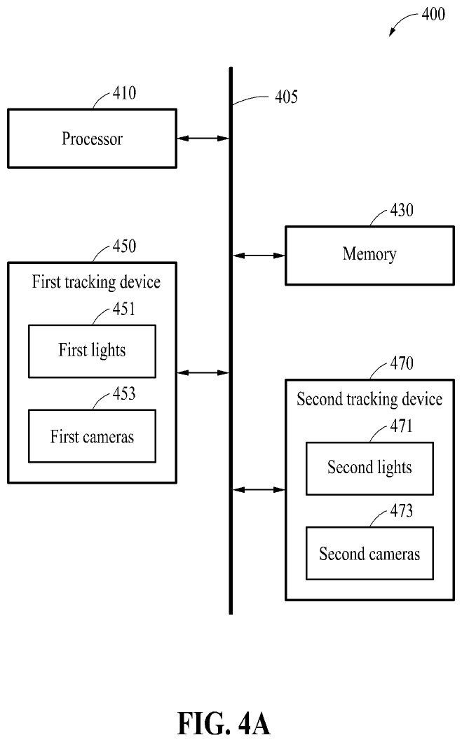

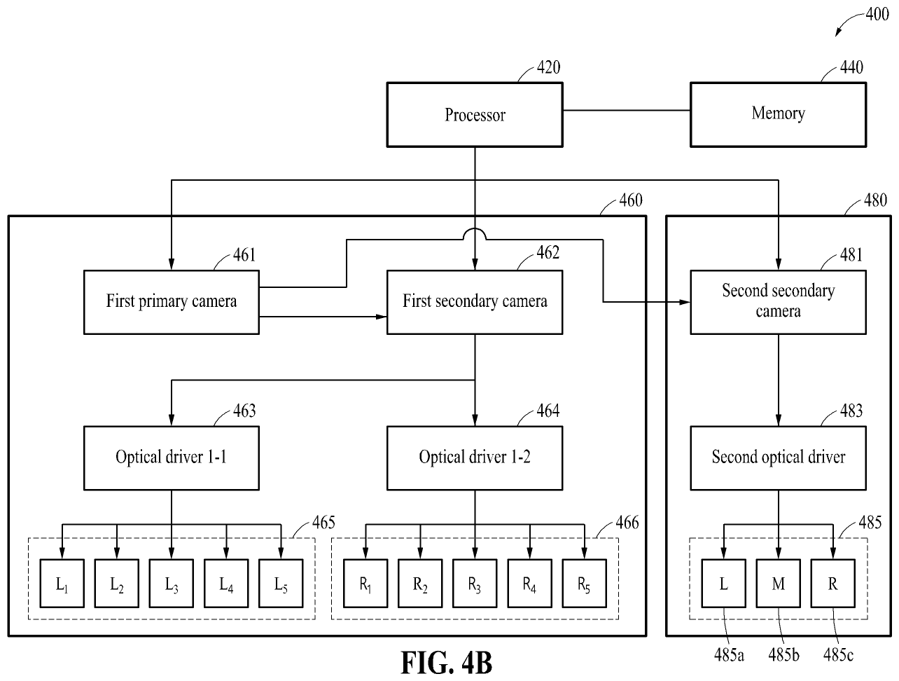

FIG. 4A is a block diagram of a wearable electronic device according to an embodiment.

Referring to FIG. 4A, according to an embodiment, a wearable electronic device 400 (e.g., the wearable electronic device 200 of FIG. 2 and/or the wearable electronic device 300 of FIGS. 3A and 3B) may include at least one processor 410 (e.g., the processor 120 of FIG. 1), memory 430 (e.g., the memory 130 of FIG. 1), a first tracking device 450, and a second tracking device 470. The wearable electronic device 400 may correspond to an electronic device worn by a user, for example, an HMD. The HMD may provide the user with an experience of feeling a virtual image as if it were real through vivid images, videos, and voices.

The wearable electronic device 400 may be worn on a face of the user and provide images related to AR, VR, and/or MR services to the user. In an embodiment, the wearable electronic device 400 may include cameras 453 and 473 to provide the AR, VR, and/or MR services to the user. The cameras 453 and 473 may acquire image frames by detecting wavelengths of a visible light region and an IR region, and the wearable electronic device 400 may use the image frames acquired by the cameras 453 and 473 to perform eye tracking (or gaze tracking) and face tracking and recognize a space.

The at least one processor 410, the memory 430, the first tracking device 450, and the second tracking device 470 may be connected to each other through a communication bus 405.

The at least one processor 410 may control a first primary camera (e.g., a first primary camera 461 of FIG. 4B) among first cameras 453 (e.g., the second cameras 275a and 275b of FIG. 2 and/or the third function cameras 328a and 328b of FIGS. 3A and 3B) to generate a first signal related to the exposure of the first primary camera and input the generated first signal as a signal notifying second cameras 473 (e.g., the fourth cameras 280a, 280b, and 280c of FIG. 2 and/or the fourth function cameras 325, 326, and 327 of FIGS. 3A and 3B) of the start of a frame. The first primary camera may be any one of the first cameras 453.

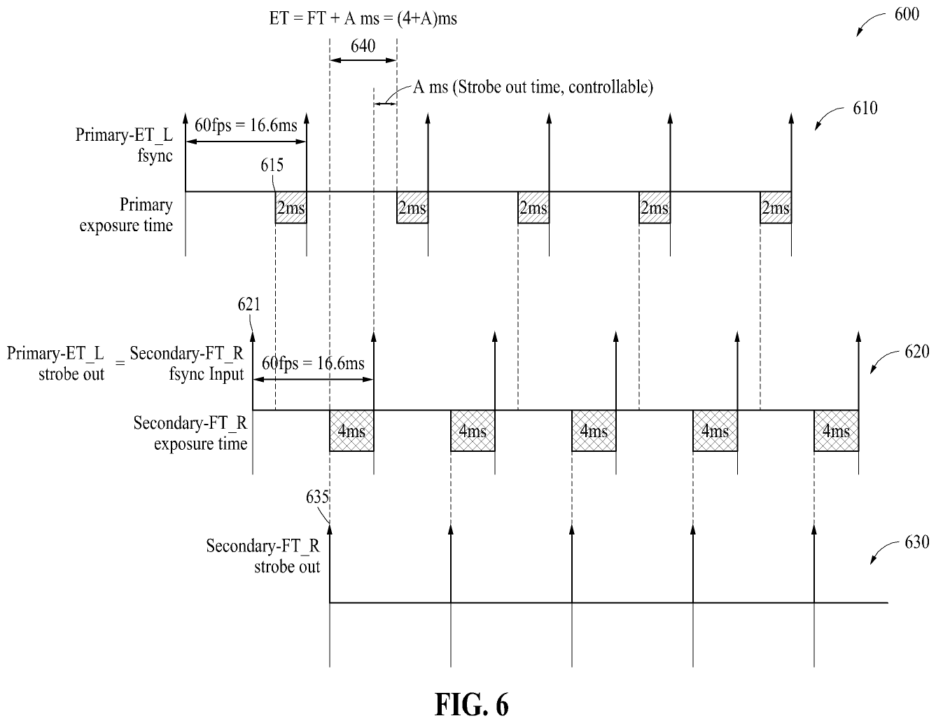

Accordingly, the first primary camera may generate the first signal (e.g., a first signal 621 of FIG. 6) related to the exposure of the first primary camera among the first cameras 453 and input the first signal as the signal notifying the second cameras 473 of the start of the frame. In this case, the “first signal related to the exposure of the first primary camera” may be, for example, a signal indicating the start of a first exposure time of the first primary camera or a signal indicating an exposure state of the first primary camera. In this case, the signal indicating the start of the first exposure time may be activated according to the first exposure time of the first primary camera or may be activated before the first exposure time. The “first signal related to the exposure of the first primary camera” may have the form of a “strobe signal.”

The first primary camera may generate the first signal at the first exposure time of the first primary camera and input the first signal as the signal notifying the second cameras 473 of the start of the frame. For example, the first primary camera may generate the first signal before the first exposure time of the first primary camera begins and input the first signal as the signal notifying to the second cameras 473 of the start of the frame. In this case, the signal notifying the second cameras 473 of the start of a frame may be, for example, a “Fsync” signal.

The first primary camera may adjust a generation time of the first signal such that the first exposure time of the first primary camera and a second exposure time of the second cameras 473 do not overlap each other. For example, the at least one processor 410 may adjust the generation time of the first signal such that an interval between the first exposure time and the second exposure time is reduced in proportion to a transmission time for transmitting one data frame by the first primary camera. For example, the first primary camera may adjust the generation time of the first signal such that the interval between the first exposure time and the second exposure time occurs within a range of less than half the transmission time for transmitting one data frame by the first primary camera. The at least one processor 410 may control the first primary camera to adjust a synchronization time for synchronizing with remaining cameras (e.g., a first secondary camera and/or the second cameras 473). A method by which the at least one processor 410 adjusts the generation time of the first signal will be described in more detail below with reference to FIG. 6.

The at least one processor 410 may input a third signal (e.g., a third signal 635 of FIG. 6) related to the exposure of the second cameras 473 as a second trigger signal corresponding to a second optical driver for second lights 471 (the lights described herein may refer to lighting units). For example, the at least one processor 410 ma input third signals related to respective exposures of a secondary camera 2-1 and a secondary camera 2-2 among the second cameras 473, as the second trigger signal corresponding to the second optical driver for the second lights 471. The terms “primary/secondary cameras” used herein may also be referred to as “master/slave cameras,” respectively.

The memory 430 may store instructions to be executed by the at least one processor 410. The instructions may be configured to cause the at least one processor 410 to execute various operations described above.

The first tracking device 450 may include first lights 451 and the first cameras 453. The first lights 451 may correspond to a first area of the user wearing the wearable electronic device 400. The first area may correspond to the eyes (both eyes) of the user, that is, a left eye and a right eye of the user, but is not necessarily limited thereto. The first lights 451 may generate images reflected on the first area (e.g., the left eye and the right eye of the user wearing the wearable electronic device 400).

In an embodiment, the wearable electronic device 400 may control a transmittance of a display to be lower as the brightness of an acquired image frame is brighter in order to prevent the user from the glare of ambient light.

The wearable electronic device 400 may acquire image frames using the cameras 453 and 473 and, when the brightness around the cameras 453 and 473 is dark, may not readily perform eye tracking, face tracking, and space recognition using the acquired image frames. In an embodiment, the wearable electronic device 400 may include IR lights (e.g., the first lights 451 and the second lights 471) to obtain image frames of brightness required for eye tracking, face tracking, and space recognition. The wearable electronic device 400 may secure a more amount of light by turning on the IR lights when the surrounding brightness is dark.

The first lights 451 may be, for example, LEDs or IR LEDs, but are not necessarily limited thereto.

The first lights 451 may operate a light source according to a control signal of first optical drivers (e.g., an optical driver 1-1 for left-eye lights and an optical driver 1-2 for right-eye lights) for 2 milliseconds (msec.), for example, but is not necessarily limited thereto.

In an embodiment, the cameras 453 and 473 may acquire image frames by detecting wavelengths in a visible light region and an IR region. Thus, when an image frame is acquired with the IR lights on, the acquired image frame may be brighter even when the surrounding environment recognized by a person is actually dark. To verify the surrounding brightness recognized by the user with the IR lights on, the wearable electronic device 400 may require a separate illuminance sensor.

According to an embodiment, the wearable electronic device 400 may acquire, with the IR lights off, image frames that are not to be used for eye tracking and face tracking among image frames to be acquired through the cameras 453 and 473, and may detect the surrounding brightness without an influence of the IR lights without an illuminance sensor by checking the acquired image frames.

The first cameras 453 may correspond to the first area. The first cameras 453 may include, for example, a first primary camera 461 and a first secondary camera 462 as shown in FIG. 4B. The first primary camera 461 may track images reflected on the left eye of the user and the left eye of the user. In this case, “tracking the left eye of the user” may be comprehensively understood as tracking not only the left eye of the user but also a gaze of the left eye. When receiving an activation signal from the at least one processor 410, the first primary camera 461 may transmit a trigger signal to the optical driver 1-1 for the left-eye lights among the first lights 451.

The first secondary camera 462 may track images reflected on the right eye of the user and the right eye of the user. Likewise, “tracking the right eye of the user” may be comprehensively understood as tracking not only the right eye of the user but also a gaze of the right eye.

The first cameras 453, for example, the first primary camera 461 and the first secondary camera 462, may be synchronized with each other. In this case, “first cameras (e.g., the first primary camera 461 and the first secondary camera 462) being synchronized with each other” may indicate that the first cameras (e.g., the first primary camera 461 and the first secondary camera 462) starts capturing images at the same time, which may also be construed that respective exposure times of the first cameras (e.g., the first primary camera 461 and the first secondary camera 462) are the same. In addition, “the first primary camera 461 and the first secondary camera 462 are synchronized with each other” may also be construed that the first lights 451 for the first primary camera 461 and the first lights 451 for the first secondary camera 462 are “turned on” or “on” at the same time.

The second tracking device 470 may include the second lights 471 and the second cameras 473. The second lights 471 may correspond to a second area of the user. The second area may correspond to the face of the user but is not necessarily limited thereto. The second lights 471 may reflect light on the second area (e.g., the face of the user). The second lights 471 may be, for example, LEDs or IR LEDs, but are not necessarily limited thereto.

The second cameras 473 may correspond to the second area. The second cameras 473 may recognize a facial expression of the user using the second lights 471. The second cameras 473 may be synchronized with each other.

The second cameras 473 may also be referred to as “second secondary cameras (e.g., second secondary cameras 481 of FIG. 4B) in that they operate based on the first signal related to the exposure of the first primary camera 461. The second cameras 473 may include a secondary camera 2-1, a secondary camera 2-2, and a secondary camera 2-3. For example, the secondary camera 2-1 may capture an image of a left side of the face of the user. The secondary camera 2-2 may capture an image of a center of the face of the user. The secondary camera 2-3 may capture an image of a right side of the face of the user.

FIG. 4B shows an arrangement between the first lights 451 and the first cameras 453 and the second lights 471 and the second cameras 473.

According to an embodiment, to implement an avatar system that uses both eye tracking and face tracking, the first tracking device 450 and the second tracking device 470 may operate on the same cycle. The first tracking device 450 and the second tracking device 470 may operate with a constant delay (e.g., a constant delay time 640 of FIG. 6) within the same cycle. The operation of the first tracking device 450 and the second tracking device 470 with a constant delay time will be described in more detail below with reference to FIG. 6.

FIG. 4B is a block diagram of a wearable electronic device according to an embodiment.

Referring to FIG. 4B, according to an embodiment, a wearable electronic device 400 (e.g., the wearable electronic device 200 of FIG. 2 and/or the wearable electronic device 300 of FIGS. 3A and 3B) may include at least one processor 420, memory 440, a first tracking device 460, and a second tracking device 480. The at least one processor 420, the memory 440, the first tracking device 460, and the second tracking device 480 may communicate with each other through a communication bus (e.g., the communication bus 405 of FIG. 4A).

The at least one processor 420 may control a first primary camera 461 to generate a first signal related to the exposure of the first primary camera 461 before a first exposure time of the first primary camera 461 begins, and input the generated first signal as a signal notifying second secondary cameras 481 (e.g., the fourth cameras 280a, 280b, and 280c of FIG. 2, and/or the fourth function cameras 325, 326, and 327 of FIGS. 3A and 3B) of the start of a frame. According to an embodiment, the processor 420, which is an auxiliary processor (e.g., the auxiliary processor 123 of FIG. 1), may be a processor (e.g., a real-time IO processor) that is connected to various sensors, such as a camera (e.g., the camera module 180 of FIG. 1) and/or components, such as a display (e.g., the display module 160 of FIG. 1) and configured to support a real-time processing operation.

For example, when the wearable electronic device 400 is to generate a facial expression of a user or an avatar, and/or is worn by the user, the first primary camera 461 may be triggered or activated to transmit the first signal. The first primary camera 461 may transmit the first signal every frame.

The first primary camera 461 may receive a signal requesting the transmission of the first signal from the at least one processor 420 (e.g., an application processor (AP)) or a signal requesting suspension of the transmission of the first signal.

The memory 440 may store instructions to be executed by the at least one processor 420. The instructions may be configured to cause the at least one processor 420 to execute various operations described above.

The first tracking device 460 may include the first primary camera 461, a first secondary camera 462, an optical driver 1-1 463, an optical driver 1-2 464, and first IR lights 465 and 466. The first primary camera 461 may track images reflected on the left eye of the user wearing the wearable electronic device 400 and/or the left eye (or a gaze of the left eye) of the user. The first secondary camera 462 may track the right eye (or a gaze of the right eye) of the user. The optical driver 1-1 463 may control left-eye lights 465 (e.g., L₁, L₂, L₃, L₄, and L₅) among the first IR lights 465 and 466 according to a second signal related to the exposure of the first secondary camera 462. The optical driver 1-2 464 may control right-eye lights 466 (e.g., R1, R2, R3, R4, and R5) among the first IR lights 465 and 466 according to the second signal related to the exposure of the first secondary camera 462. The first IR lights 465 and 466 may generate images reflected on the left eye and the right eye of the user wearing the wearable electronic device 400. A case where the number of first IR lights 465 and 466 is shown as 10 has been described as an example with reference to FIG. 4B, but examples are not necessarily limited thereto. The various numbers of first IR lights 465 and 466 may be provided as needed.

The second tracking device 480 may include second secondary cameras 481, a second optical driver 483, and second IR lights 485 (e.g., L 485a, M 485b, and R 485c).

The second secondary cameras 481 may recognize a facial expression of the user using the second IR lights 485. The second secondary cameras 481 may include a secondary camera 2-1, a secondary camera 2-2, and a secondary camera 2-3. The secondary camera 2-1 may capture an image of the left side of the face of the user. The secondary camera 2-2 may capture an image of the center of the face of the user. The secondary camera 2-3 may capture an image of the right side of the face of the user.

The second optical driver 483 may control the second IR lights 485 according to a third signal related to the exposure of the second secondary cameras 481.

The second IR lights 485 (e.g., L 485a, M 485b, and R 485c) may reflect light on the face of the user. The second IR light L 485a may reflect light on the left side of the face of the user. The second IR light M 485b may reflect light on the center of the face of the user (e.g., between the eyebrows). The second IR light R 485c may reflect light on the right side of the face of the user.

The memory 430 or 440 of FIGS. 4A and 4B may store at least one program including an application to be described below. The memory 430 or 440 may also store various information generated during processing by the at least one processor 410 or 420. In addition, the memory 430 or 440 may store various data and programs. The memory 430 or 440 may include volatile memory (e.g., the volatile memory 132 of FIG. 1) or non-volatile memory (e.g., the non-volatile memory 134 of FIG. 1). The memory 430 or 440 may be equipped with a high-capacity storage medium, such as a hard disk to store various data.

In addition, the at least one processor 410 or 420 may perform at least one method or corresponding technique related to the wearable electronic device 400 described with reference to FIGS. 4A, 4B, 5, 6, 7A, 7B, 8, and 9. The at least one processor 410 or 420 may be a hardware-implemented electronic device having a physically structured circuit for executing desired operations. The desired operations may include, for example, code or instructions included in a program. Such a hardware-implemented wearable electronic device 400 may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and/or a neural processing unit (NPU).

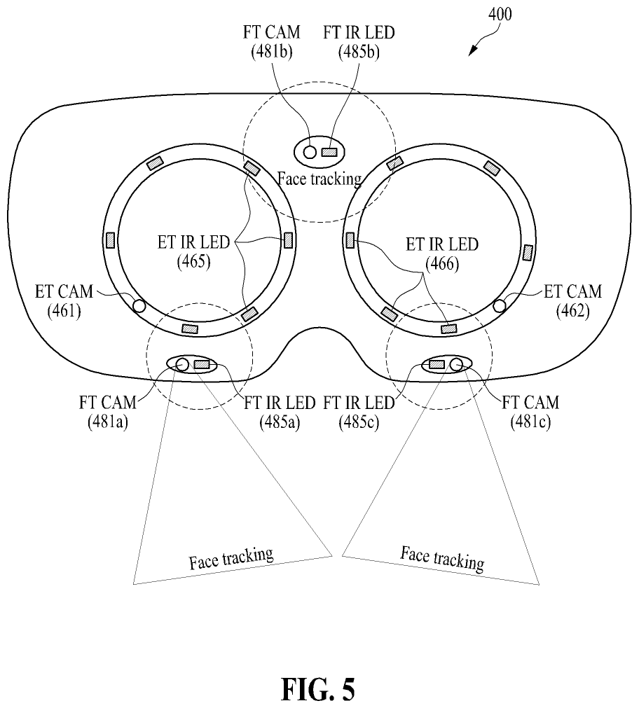

FIG. 5 is a diagram showing arrangement positions of cameras and lights of a first tracking device and a second tracking device in a wearable electronic device according to an embodiment of the disclosure

Referring to FIG. 5, in the wearable electronic device 400 (e.g., the wearable electronic device 200 of FIG. 2 and/or the wearable electronic device 300 of FIGS. 3A and 3B) according to an embodiment, first cameras (e.g., the first primary camera 461, the first secondary camera 462 (e.g., the second cameras 275a and 275b of FIG. 2 and/or the third function cameras 328a and 328b of FIGS. 3A and 3B) of a first tracking device (e.g., the first tracking device 460 of FIG. 4B) may be disposed at a position (e.g., on the side of each eye) from which a left eye and a right eye (or respective gazes of the left eye and the right eye) of a user may be tracked. The first cameras 461 and 462 may recognize the irises of the left eye and the right eye of the user. In this case, first lights (e.g., 465 and 466), which are provided as a plurality of first lights, may be arranged at positions surrounding the eyes to reflect multiple glint images on each of the left eye and the right eye of the user. The first cameras 461 and 462 may capture the glint images reflected on the left eye and the right eye of the user by the first lights 465 and 466.

In the wearable electronic device 400, second cameras (e.g., the secondary camera 2-1 481a, the secondary camera 2-2 481b, and the secondary camera 2-3 481c) (e.g., the fourth cameras 280a, 280b, and280c of FIG. 2 and/or the fourth function cameras 325, 326, and 327 of FIGS. 3A and 3B) of a second tracking device may be disposed at positions from which a facial expression of the user (e.g., smiling, frowning, crying, or angry expression) may be recognized. The second cameras 481a, 481b, and 481c may be disposed at a position from which an expression of a lower part of the face of the user wearing the wearable electronic device 400 is recognized and/or a position from which an expression between the eyebrows of the user is recognized. In this case, second lights 485a, 485b, and 485c may be disposed adjacent to the second cameras 481a, 481b, and 481c to reflect IR light on the face of the user, and may be configured such that the second cameras 481a, 481b, and 481c capture images of the face with the reflected IR light. The wearable electronic device 400 may analyze the captured images of the face of the user, recognize a facial expression, and then implement an expression of an avatar corresponding to the recognized facial expression.

In this case, as indicated by a broken line in FIG. 5, two first lights positioned at a lower end among the first lights 465 (or ET IR LED) for the first primary camera 461 and the second light 485a of the secondary camera 2-1 481a may be arranged adjacent to each other, and some (e.g., two) first lights positioned at the lower end among the first lights 466 (or ET IR LED) for the first secondary camera 462 and the second light 485c of the secondary camera 2-3 481c may be arranged adjacent to each other. In addition, the second light 485b for the secondary camera 2-2 481b may be arranged adjacent to the first lights 465 (ET IR LED) and/or the first lights 466 (ET IR LED) positioned near a position between the eyebrows of the user.

In this structure in which some lights are arranged in close proximity, for example, when the first lights 465 and 466 and the second lights 485a, 485b, and 485c are turned on at the same time, or the first lights 465 and 466 flow into the second cameras (e.g., the secondary camera 2-1 481a, the secondary camera 2-2 481b, and the secondary camera 2-3 481c) along with the second lights 485a, 485b, and 485c, the images captured by the second cameras may have parts having a great brightness difference due to the influence of the first lights 465 and 466.

A phenomenon in which an image captured by a corresponding camera (e.g., a second camera) by another light (e.g., a first light) for another camera (e.g., a first cameras), not by a light (e.g., a second light) for the corresponding camera (e.g., the second camera), is affected by interference (e.g., brightness difference) may be referred to as “crosstalk.”

According to an embodiment, the wearable electronic device 400 may adjust an exposure time for a first image-capturing device (or “first exposure time”) and an exposure time for a second image-capturing device (or “second exposure time”) such that they do not overlap each other, and may thereby prevent crosstalk that may occur by first lights and second lights. A method by which the wearable electronic device 400 adjusts the first exposure time and the second exposure time will be described in more detail below with reference to FIG. 6.

FIG. 6 is a diagram 600 showing a temporal relationship between image frames and lights used in a wearable electronic device according to an embodiment of the disclosure.

Referring to FIG. 6, a timing diagram 610 shows a first exposure time (e.g., Primary Exposure time) of a first primary camera (e.g., Primary-ET_L) (e.g., the first primary camera 461 of FIG. 4B) in a wearable electronic device (e.g., the wearable electronic device 200 of FIG. 2) according to a signal (e.g., Fsync) indicating the start of a frame of the first primary camera, a timing diagram 620 shows a second exposure time (e.g., Secondary FT_R Exposure time) of a second secondary camera (e.g., FT_R) (e.g., the second secondary cameras 481 of FIG. 4B) according to a first signal 621 (e.g., Strobe out) related to the exposure of the first primary camera output from the first primary camera, and a timing diagram 630 shows a generation time of a third signal 635 (e.g., Strobe out) related to the exposure of the second secondary camera (e.g., Secondary FT_R).

A “signal (e.g., Fsync) indicating the start of a frame” used herein may correspond to an I/O that may control a start time of the frame. A “signal (e.g., Strobe) related to the exposure of a camera” used herein may correspond to an I/O that may notify the wearable electronic device of a start time at which an exposure (e.g., light exposure) time of the camera begins. The wearable electronic device may generate the signal (e.g., Strobe) related to the exposure of a camera before the exposure time of the camera begins. In an embodiment, using the signal (e.g., Fsync) indicating the start of a frame and the signal (e.g., Strobe) related to the exposure of a camera may prevent crosstalk from occurring between a first tracking device (e.g., the first tracking device 450 of FIG. 4A and/or the first tracking device 460 of FIG. 4B) and a second tracking device (e.g., the second tracking device 470 of FIG. 4A and/or the second tracking device 480 of FIG. 4B).

For example, when the signal (e.g., Fsync) indicating the start of a frame of a first primary camera (e.g., ET_L) occurs in the first tracking device (e.g., the first tracking device 450 of FIG. 4A and/or the first tracking device 460 of FIG. 4B), the first primary camera ET_L may capture image frames for 16.6 ms (e.g., 60 frames per second (fps)=16.6 ms) and transmit the image frames. In this case, the wearable electronic device may adjust a generation time of the first signal 621 (e.g., Strobe out) related to the exposure of the first primary camera ET_L such that the first exposure time of the first primary camera ET_L and the second exposure time of a second secondary camera FT_R of the second tracking device (e.g., the second tracking device 470 of FIG. 4A and/or the second tracking device 480 of FIG. 4B) do not overlap each other.

The wearable electronic device may generate an output (e.g., Strobe Output) of the first signal 621 related to the exposure of the first primary camera ET_L before the first exposure time (e.g., 615) of the first tracking device (e.g., the first primary camera ET_L) begins and use it as a signal input (e.g., Fsync Input) that indicates the start of a frame of the second tracking device (e.g., the second secondary camera FT_R), thereby generating a delay between the first exposure time of the first tracking device (e.g., the first primary camera ET_L) and the second exposure time of the second tracking device (e.g., the second secondary camera FT_R). In this case, by the delay between the first exposure time of the first tracking device and the second exposure time of the second tracking device, the first exposure time and the second exposure time may not overlap each other. In this case, the signal (Fsync) indicating the start of the frame of the second tracking device (e.g., the second secondary camera FT_R) may correspond to a signal notifying the second secondary camera FT_R of having to count 16.6 ms from a current point in time. The second secondary camera FT_R may perform the exposure for 4 ms according to a third signal 635 (e.g., Strobe out) that occurs 4 ms before (or slightly before) the end of 16.6 ms according to the count. During the exposure of the second secondary camera FT_R, second lights for the second secondary camera FT_R may also be turned on.

For example, the wearable electronic device may adjust a generation time of a first signal such that a second exposure time (e.g., FT CAM Exposure time) is less than a value obtained by subtracting a first exposure time (e.g., ET CAM Exposure time) from a transmission time (1 frame time=16.6 ms) of one data frame transmitted by a first primary camera, and may thereby prevent crosstalk between the first tracking device and the second tracking device from occurring. In this case, the first tracking device and the second tracking device may operate on the same cycle, but operate with a constant delay time 640 within the same cycle, and may thus more accurately reflect a facial expression including a gaze of the user in an avatar system. In this case, the constant delay time 640 may be, for example, (second exposure time (4 ms)+A ms), based on a start point of an exposure time of each of cameras of the first tracking device and the second tracking device. In this case, A ms may be controlled (or adjusted) by the first signal 621 (e.g., Strobe out).

Referring to the timing diagrams 610 and 620 shown in FIG. 6, the first exposure time of the first primary camera may be, for example, 2 ms, and the second exposure time of the second secondary camera (e.g., FT_R) may be, for example, 4 ms, but are not necessarily limited thereto. The first exposure time of the first primary camera and the second exposure time of the second secondary camera may vary depending on embodiments.

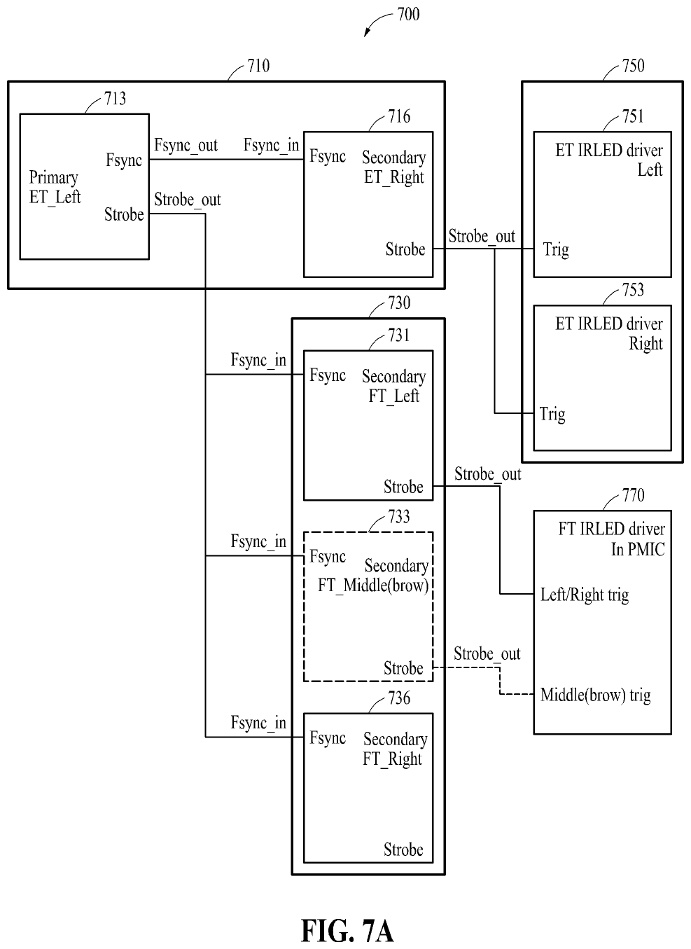

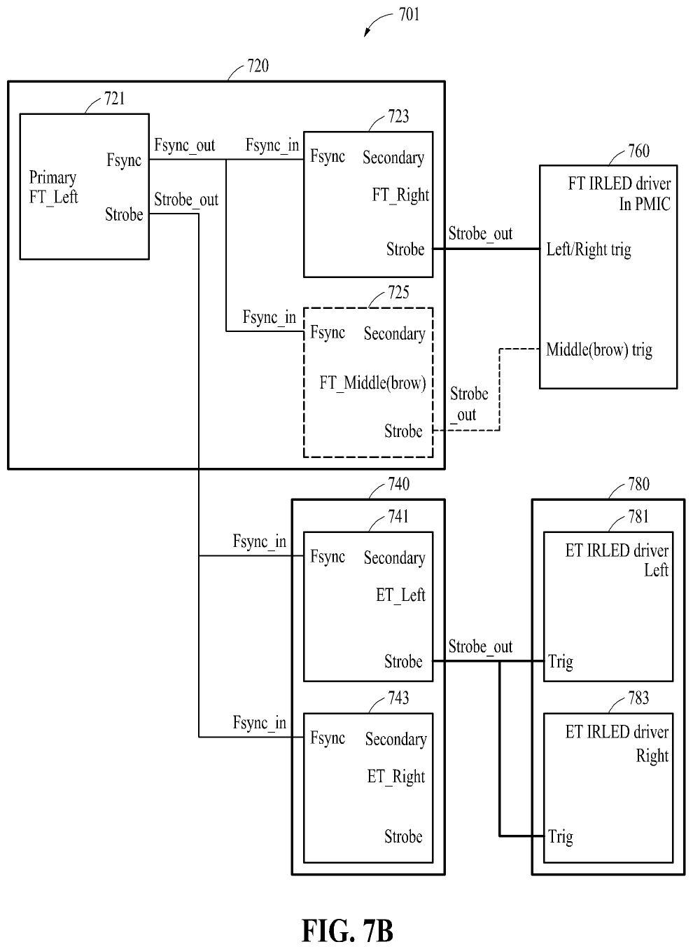

FIG. 7A is a diagram showing an input/output relationship between a primary camera and secondary cameras in a wearable electronic device according to an embodiment of the disclosure.

According to an embodiment, FIG. 7A shows an input/output relationship in a wearable electronic device 700 (e.g., the wearable electronic device 200 of FIG. 2, the wearable electronic device 300 of FIGS. 3A and 3B, and/or the wearable electronic device 400 of FIGS. 4A and 4B) that sets, as a primary camera, any one among first cameras 713 and 716 (e.g., the second cameras 275a and 275b of FIG. 2, the third function cameras 328a and 328b of FIGS. 3A and 3B, the first cameras 453 of FIG. 4A, and/or the first primary camera 461 and the second secondary camera 462 of FIG. 4B) of a first tracking device 710 (e.g., the first tracking device 450 of FIG. 4A and/or the first tracking device 460 of FIG. 4B) for tracking a gaze (or eyes) of a user and sets, as a secondary camera, another one of the first cameras 713 and 716 and second cameras of a second tracking device 730 (e.g., the second tracking device 470 of FIG. 4A and/or the second tracking device 480 of FIG. 4B).

The wearable electronic device 700 may include the first tracking device 710, the second tracking device 730, a first optical driver 750 (e.g., the first optical drivers 463 and 464 of FIG. 4B), and a second optical driver 770 (e.g., the second optical driver 483 of FIG. 4B).

The first tracking device 710 may include a left-eye camera (e.g., ET_Left) that is a first primary camera 713 (e.g., the first primary camera 461 of FIG. 4B) and a right-eye camera (e.g., ET_Right) that is a first secondary camera 716 (e.g., the first secondary camera 462 of FIG. 4B). The second tracking device 730 may include second secondary cameras (e.g., a secondary camera 2-1 731, a secondary camera 2-2 733, and a secondary camera 2-3 736) (e.g., the second cameras 473 of FIG. 4A and/or the second secondary cameras 481 of FIG. 4B).

The first optical driver 750 may control setting values (e.g., illuminance (intensity), direction, and/or a light to be turned on/off) of first lights (e.g., the first lights 451 of FIG. 4A and/or the first IR lights 465 and 466 of FIG. 4B) for the first cameras 713 and 716, according to a control signal of a processor (e.g., the processor 120 of FIG. 1, the processor 410 of FIG. 4A, and/or the processor 420 of FIG. 4B).

The first optical driver 750 may include an optical driver 1-1 751 (e.g., ET IR LED Driver Left) for left-eye lights among first IR lights, and an optical driver 1-2 753 (e.g., ET IR LED Driver Right) for right-eye lights among the first IR lights.

The second optical driver 770 may adjust setting values (e.g., illuminance (intensity), direction, and/or a light to be turned on/off) of second lights (e.g., the second lights 471 of FIG. 4A and/or the second IR lights 485a, 485b, and 485c of FIG. 4B) for the cameras 731, 733, and 736 (e.g., the fourth cameras 280a, 280b, and 280c of FIG. 2, the fourth function cameras 325, 326, and 327 of FIGS. 3A and 3B, the second cameras 473 of FIG. 4A, and/or the second cameras 481a, 481b, and 481c of FIG. 4B) of the second tracking device 730 according to a control signal of the processor (e.g., the processor 120 of FIG. 1, the processor 410 of FIG. 4A, and/or the processor 420 of FIG. 4B). In this case, settings values of the cameras of the second tracking device 730 may also be adjusted according to the control signal of the processor (e.g., the processor 120 of FIG. 1, the processor 410 of FIG. 4A, and/or the processor 420 of FIG. 4B).

According to an embodiment, whether the second lights for the cameras 731, 733, and 736 of the second tracking device 730 are turned on/off, that is, the synchronization of the second lights may be controlled by a first signal transmitted from the first primary camera 713. The second optical driver 770 may be positioned, for example, on a power management integrated circuit (PMIC) for a mobile application processor.

For example, the secondary camera 2-1 731 may be a camera (e.g., FT_Left) that captures an image of a left side of a face of the user. The secondary camera 2-2 733 may be a camera (e.g., FT_Middle (brow)) that captures an image of a center (e.g., between the eyebrows) of the face of the user. The secondary camera 2-3 736 may be a camera (e.g., FT_Right) that captures an image of a right side of the face of the user. Not all the second secondary cameras 731, 733, and 736 may be used necessarily but, depending on embodiments, the secondary camera 2-1 731 and the secondary camera 2-3 736 may be used and secondary camera 2-2 733 may be used selectively.

The wearable electronic device 700 may input a signal (e.g., Fsync out) indicating the start of a frame output from the first primary camera 713 as a signal (e.g., Fsync in) notifying the first secondary camera 716 of the start of the frame. In this case, because the first primary camera 713 and the first secondary camera 716 may be synchronized with each other, even when a signal for the first primary camera 713 is used as a signal for the first secondary camera 716, a time synchronization-related issue may not arise between them.

The wearable electronic device 700 may input a first signal (e.g., Strobe out) related to the exposure of the first primary camera 713 as a signal (e.g., Fsync in) notifying the second secondary cameras 731, 733, and 736 of the start of the frame.

The wearable electronic device 700 may input a second signal (e.g., Strobe out) related to the exposure of the first secondary camera 716 as a first trigger signal (e.g., TRIG) corresponding to the optical driver 1-1 751 and the optical driver 1-2 753. As will be described below, the optical driver 1-1 751 and the optical driver 1-2 735 may operate in a master and slave form and communicate with an AP through I2C communication.

In addition, the wearable electronic device 700 may input a third signal (e.g., Strobe out) related to the exposure of the second cameras 731, 733, and 736 as a second trigger signal corresponding to the second optical driver 770. For example, the wearable electronic device 700 may input third signals related to respective exposures of the secondary camera 2-1 731 and the secondary camera 2-2 733 among the second cameras 731, 733, and 736, as the second trigger signal corresponding to the second optical driver 770. In this case, the third signal related to the exposure of the secondary camera 2-1 731 may be input as a trigger signal for controlling lights that illuminate the left side and the right side of the face of the user among the second lights controlled by the second optical driver 770. Also, the third signal related to the exposure of the secondary camera 2-2 733 may be input as a trigger signal (e.g., Middle (Brow)) controlling a light that illuminates the center of the face of the user among the second lights controlled by the second optical driver 770. In this case, separating a trigger signal as described above may be to prepare for a case in which the secondary camera 2-1 731 and the secondary camera 2-3 736 among the second cameras are used, and the secondary camera 2-2 733 among the second cameras is used selectively, depending on embodiments. According to an embodiment, the trigger signal controlling the lights that illuminate the left and right sides of the face of the user among the second lights and the trigger signal (e.g., Middle (Brow) TRIG) controlling the light that illuminates the center of the face of the user among the second lights may allow one of the second cameras 731, 733, and 736 to input the third signal to the optical driver 770. Although the secondary camera 2-1 731 is shown in FIG. 7A as inputting the third signal as the trigger signal controlling the lights that illuminate the left and right sides of the face of the user among the second lights controlled by the second optical driver 770, the secondary camera 2-3 736 may input the signal as the trigger signal controlling the lights that illuminate the left and right sides of the face of the user among the second lights controlled by the second optical driver 770.

FIG. 7B is a diagram showing an input/output relationship between a primary camera and secondary cameras in a wearable electronic device according to an embodiment of the disclosure.

According to an embodiment, FIG. 7B shows an input and output relationship in a wearable electronic device 701 (e.g., the wearable electronic device 200 of FIG. 2, the wearable electronic device 300 of FIGS. 3A and 3B, the wearable electronic device 400 of FIGS. 4A and 4B, and/or the wearable electronic device 700 of FIG. 7A) that sets, as a primary camera (e.g., a camera 2-1 721), any one among three cameras 721, 723, and 725 of a second tracking device 720 (e.g., the second tracking device 470 of FIG. 4A, the second tracking device 480 of FIG. 4B, and/or the second tracking device 730 of FIG. 7A) for tracking a face of a user and sets, as a secondary camera, the remaining two cameras (e.g., a camera 2-2 723 and a camera 2-3 725) and cameras 741 and 743 of a first tracking device 740 (e.g., the first tracking device 450 of FIG. 4A, the first tracking device 460 of FIG. 4B, and/or the first tracking device 710 of FIG. 7A) for tracking a gaze (or eyes) of the user.

The wearable electronic device 701 may include the second tracking device 720, the first tracking device 740, a second optical driver 760 (e.g., the second optical driver 483 of FIG. 4B and/or the second optical driver 770 of FIG. 7A), and a first optical driver 780 (e.g., the first optical drivers 463 and 464 of FIG. 4B and/or the first optical driver 750 of FIG. 7A).

The second tracking device 720 may include a first primary camera (e.g., the camera 2-1 721) and first secondary cameras (e.g., the camera 2-2 723 and the camera 2-3 725).

The first tracking device 740 may include second secondary cameras (e.g., a left-eye camera 741 (e.g., ET_Left) and a right-eye camera 743 (e.g., ET_Right).

The second optical driver 760 may control setting values (e.g., illuminance (intensity), direction, and/or a light to be turned on/off) of second lights (e.g., the second lights 471 of FIG. 4A and/or the second IR lights 485a, 485b, and 485c of FIG. 4B) for the cameras 721, 723, and 725 of the second tracking device 720 according to a control signal of a processor (e.g., the processor 120 of FIG. 1, the processor 140 of FIG. 4A, the processor 410 of FIG. 4A, and/or the processor 420 of FIG. 4B). The second optical driver 760 may be positioned, for example, in a PMIC for a mobile AP.

The second optical driver 760 may control the second lights for the cameras 721, 723, and 725 of the second tracking device 720 to be turned on or off according to a control signal of the second tracking device 720.

The first optical driver 780 may include an optical driver 1-1 781 (e.g., ET IR LED Driver Left) for left-eye lights among first IR lights (e.g., the first lights 451 of FIG. 4A and/or the first IR lights 465 and 466 of FIG. 4B), and an optical driver 1-2 783 (e.g., ET IR LED Driver Right) for right-eye lights among the first IR lights.

For example, the camera 2-1 721, which is the first primary camera, may be a camera (e.g., FT_Left) that captures an image of a left side of the face of the user. The camera 2-2 723, which is the first secondary camera, may be a camera (e.g., FT_Right) that captures an image of a right side of the face of the user. The camera 2-3 725, which is the first secondary camera, may be a camera (e.g., FT_Middle (Brow)) that captures an image of a center (e.g., between the eyebrows) of the face of the user. Not all the first secondary cameras 723 and 725 may be used necessarily but, depending on embodiments, the camera 2-3 725 may be used, and the camera 2-2 723 may be used selectively.

Referring to FIG. 7B, the wearable electronic device 701 may input a signal (e.g., Fsync out) indicating the start of a frame output from the camera 2-1 721 that is the first primary camera, as a signal (e.g., Fsync in) notifying the camera 2-2 723 and the camera 2-3 725 that are the first secondary cameras of the start of the frame. In this case, because the camera 2-1 721 that is the first primary camera, and the first secondary cameras 723 and 725 are synchronized with each other, and even when a signal for the camera 2-1 721 is used as a signal for the camera 2-2 723 or the camera 2-3 725 that is the first secondary camera, a time synchronization-related issue may not arise between them.

The wearable electronic device 701 may input a first signal (e.g., Strobe out) related to the exposure of the camera 2-1 721 that is the first primary camera, as a signal (e.g., Fsync in) notifying the second secondary cameras 741 and 743 of the start of the frame.

The wearable electronic device 701 may input a second signal (e.g., Strobe out) related to the exposure of the camera 2-2 723 that is the first secondary camera, as a second trigger signal corresponding to the second optical driver 760. For example, the wearable electronic device 701 may input a third signal related to the exposure of the camera 2-2 723 among the second cameras 721, 723, and 725, as a trigger signal (e.g., Left/Right TRIG) for controlling lights that illuminate the left and right sides of the face of the user among the second lights controlled by the second optical driver 760. The wearable electronic device 701 may input a signal related to the exposure of the camera 2-3 725 among the second cameras 721, 723, and 725, as a trigger signal (e.g., Middle (Brow) TRIG) for controlling lights that illuminate a center of the face of the user among the second lights controlled by the second optical driver 760. In this case, separating the trigger signals as described above may be to prepare for a case where the camera 2-3 725 among the second cameras is selectively used depending on embodiments.

In addition, the wearable electronic device 701 may input a signal (e.g., Strobe out) related to the exposure of the first cameras 741 and 743 that are second secondary cameras, as a first trigger signal corresponding to the first optical driver 780. For example, the wearable electronic device 701 may input a signal (e.g., Strobe out) related to the exposure of the first camera 741 as a first trigger for each of the optical driver 1-1 781 and the optical driver 1-2 783. Although the first camera 741 is shown in FIG. 7B as inputting the first trigger signal for each of the optical driver 1-1 781 and the optical driver 1-2 783, the first camera 743 may input the first trigger signal for each of the optical driver 1-1 781 and the optical driver 1-2 783.

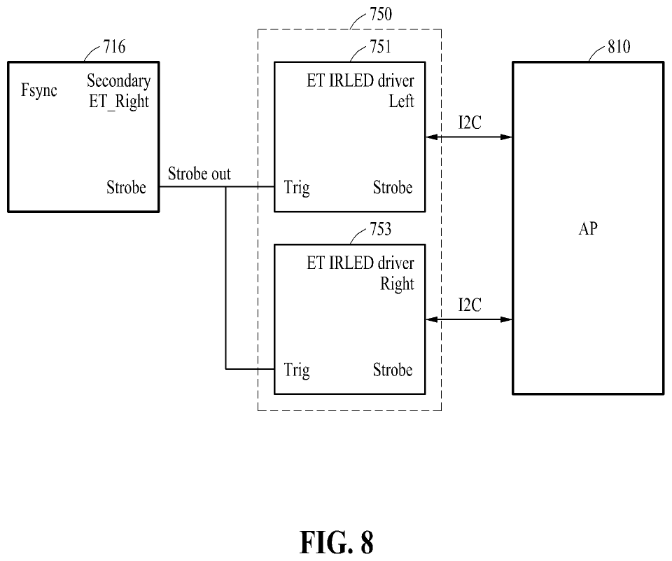

FIG. 8 is a diagram showing an operation between optical drivers for first lights of a first tracking device and an AP in a wearable electronic device according to an embodiment of the disclosure.

Referring to FIG. 8 shows a state in which a first signal (e.g., Strobe out) related to the exposure of a right-eye camera (e.g., ET_Right), which is the first secondary camera 716, is connected as a trigger input of a first optical driver (e.g., the optical driver 1-1 751 and the optical driver 1-2 753).

The optical driver 1-1 751 and the optical driver 1-2 753 may operate in a master and slave form and communicate with an AP 810 (e.g., the processor 120 of FIG. 1, the processor 410 of FIG. 4A, and/or the processor 420 of FIG. 4B) by I2C communication. I2C communication described herein may be performed using a serial computer bus. I2C communication may use two bidirectional open-collector lines, serial data (SDA) and serial clock (SCL), to which pull-up resistors are connected. In this case, the master may output a clock for synchronization as an SCL, and the slave may both transmit and receive SDA according to the clock output as the SCL.

The AP 810 may control each of the optical driver 1-1 751 and the optical driver 1-2 753 according to an application program. For example, the AP 810 may select channels (e.g., what number of lights to be turned on at which position among ten first lights), and transmit a signal for controlling the amount of light of the lights that are turned on and/or a current value to each of the optical driver 1-1 751 and the optical driver 1-2 753.

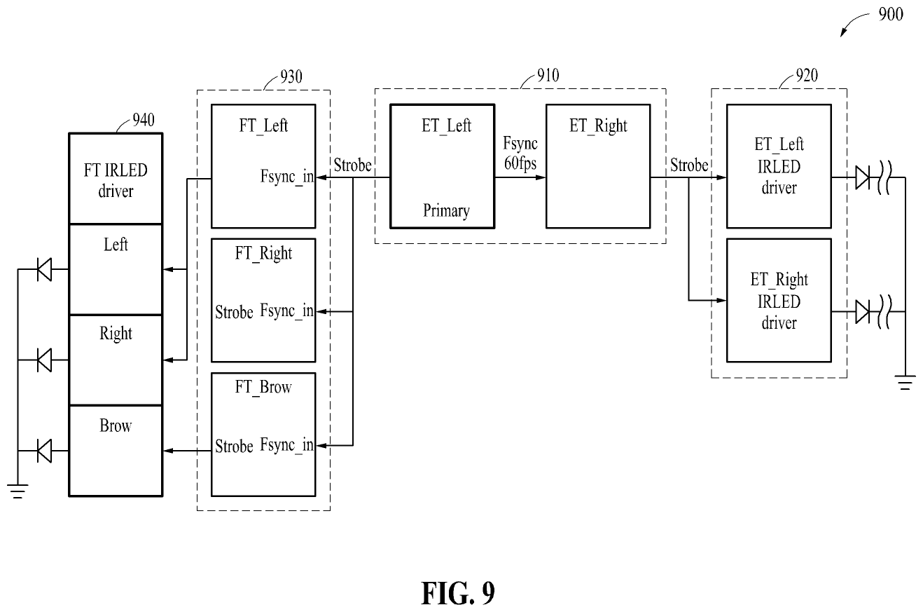

FIG. 9 is a diagram showing an example arrangement of a first tracking device, a second tracking device, and optical drivers in a wearable electronic device according to an embodiment of the disclosure.

Referring to FIG. 9, in a wearable electronic device 900 (e.g., the wearable electronic device 200 of FIG. 2, the wearable electronic device 300 of FIGS. 3A and 3B, the wearable electronic device 400 of FIGS. 4A and 4B, the wearable electronic device 700 of FIG. 7A, and/or the wearable electronic device 701 of FIG. 7B), with respect to a left-eye camera (e.g., ET_Left) that is used as a primary camera of a first tracking device 910 (e.g., the first tracking device 450 of FIG. 4A, the first tracking device 460 of FIG. 4B, the first tracking device 710 of FIG. 7A, and the first tracking device 740 of FIG. 7B), a right-eye camera (e.g., ET_Right) that is a first secondary camera and a first optical driver 920 (e.g., the first optical drivers 463 and 464 of FIG. 4B, the first optical driver 753 of FIG. 7A, and/or the first optical driver of FIG. 7B) for the first tracking device 910 may be disposed on the right side, and a second tracking device 930 (e.g., the second tracking device 470 of FIG. 4A, the second tracking device 480 of FIG. 4B, the second tracking device 730 of FIG. 7A, and/or the second tracking device 720 of FIG. 7B) and a second optical driver 940 (e.g., the second optical driver 483 of FIG. 4B, the second optical driver 770 of FIG. 7A, and/or the second optical driver 760 of FIG. 7B) for the second tracking device 930 may be disposed on the left side, but examples are not necessarily limited thereto.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various embodiments of the disclosure and the terms used therein are not intended to limit the technological features set forth herein to particular example embodiments and include various changes, equivalents, or replacements for a corresponding embodiment. In connection with the description of the drawings, like reference numerals may be used for similar or related components. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. Terms, such as “first” “second,” or “initial” or “next” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, a wearable electronic device (200, 300, 400, 700, 701, 900) may include at least one processor (120, 410, 420), memory (130, 430, 440) storing instructions to be executed by the processor (120, 410, 420), a first tracking device (450, 460, 710, 740, 910) including first lights (451, 465, 466) corresponding to a first area of a user wearing the wearable electronic device (200, 300, 400, 700, 701, 900) and first cameras (275a, 275b, 328a, 328b, 453, 461, 462, 713, 716, 723, 725) corresponding to the first area, and a second tracking device (470, 480, 730, 720, 930) including second lights (471, 485a, 485b, 485c) corresponding to a second area of the user and second cameras (280a, 280b, 280c, 325, 326, 327, 473, 721, 723, 725, 731, 733, 736) corresponding to the second area. When executed by the processor (120, 410, 420), the instructions may cause the processor (120, 410, 420) to control a first primary camera (461, 713, 721) among the first cameras (275a, 275b, 328a, 328b, 453, 461, 462, 713, 716, 723, 725) to generate a first signal (621) related to exposure of the first primary camera (461, 713, 721) and input the first signal (621) as a signal notifying the second cameras (280a, 280b, 280c, 325, 326, 327, 473, 721, 723, 725, 731, 733, 736) of start of a frame.

According to an embodiment, for the inputting as the signal notifying the second cameras (280a, 280b, 280c, 325, 326, 327, 473, 721, 723, 725, 731, 733, 736) of the start of the frame, the instructions may cause the processor (120, 410, 420) to control the first primary camera (461, 713, 721) to generate the first signal (621) at a first exposure time of the first primary camera (461, 713, 721) and input the first signal (621) as the signal notifying the second cameras (280a, 280b, 280c, 325, 326, 327, 473, 721, 723, 725, 731, 733, 736) of the start of the frame.

According to an embodiment, for the inputting as the signal notifying the second cameras (280a, 280b, 280c, 325, 326, 327, 473, 721, 723, 725, 731, 733, 736) of the start of the frame, the instructions may cause the processor (120, 410, 420) to control the first primary camera (461, 713, 721) to adjust a generation time of the first signal (621) such that the first exposure time of the first primary camera (461, 713, 721) and a second exposure time of the second cameras (280a, 280b, 280c, 325, 326, 327, 473, 721, 723, 725, 731, 733, 736) do not overlap each other.

According to an embodiment, for the adjusting of the generation time of the first signal (621), the instructions may cause the processor (120, 410, 420) to control the first primary camera (461, 713, 721) to adjust the generation time of the first signal (621) such that an interval between the first exposure time and the second exposure time decreases in proportion to a transmission time for which the first primary camera (461, 713, 721) transmits one data frame.

According to an embodiment, for the adjusting of the generation time of the first signal (621), the instructions may cause the processor (120, 410, 420) to control the first primary camera (461, 713, 721) to adjust the generation time of the first signal (621) such that the second exposure time is less than or equal to a value obtained by subtracting the first exposure time from the transmission time of one data frame transmitted by the first primary camera (461, 713, 721).

According to an embodiment, the first area may correspond to a left eye of the user and a right eye of the user, and the first tracking device (450, 460, 710, 740, 910) may include the first lights (451, 465, 466) configured to generate images reflected on the left eye and the right eye of the user wearing the wearable electronic device (200, 300, 400, 700, 701, 900), the first primary camera (461, 713, 721) configured to track the images reflected on the left eye of the user and the left eye of the user, and a first secondary camera (462, 716, 723, 725) configured to track the images reflected on the right eye of the user and the right eye of the user.

According to an embodiment, the second area may correspond to a face of the user, and the second tracking device (470, 480, 730, 720, 930) may include the second lights (471, 485a, 485b, 485c) configured to reflect light on the face of the user, and the second cameras (280a, 280b, 280c, 325, 326, 327, 473, 721, 723, 725, 731, 733, 736) configured to recognize a facial expression of the user by the second lights (471, 485a, 485b, 485c).

According to an embodiment, the first cameras (275a, 275b, 328a, 328b, 453, 461, 462, 713, 716, 723, 725) may be synchronized with each other.

According to an embodiment, the second cameras (280a, 280b, 280c, 325, 326, 327, 473, 721, 723, 725, 731, 733, 736) may be synchronized with each other.

According to an embodiment, the first tracking device (450, 460, 710, 740, 910) and the second tracking device (470, 480, 730, 720, 930) may operate with a constant delay within the same cycle.

According to an embodiment, when executed by the processor (120, 410, 420), the instructions may cause the processor (120, 410, 420) to input a signal notifying start of a frame output from the first primary camera (461, 713, 721) as a signal notifying a first secondary camera (462, 716, 723, 725) among the first cameras (275a, 275b, 328a, 328b, 453, 461, 462, 713, 716, 723, 725) of the start of the frame.

According to an embodiment, when executed by the processor (120, 410, 420), the instructions may cause the processor (120, 410, 420) further to input a second signal related to exposure of a first secondary camera (462, 716, 723, 725) among the first cameras (275a, 275b, 328a, 328b, 453, 461, 462, 713, 716, 723, 725) as a first trigger signal corresponding to an optical driver 1-1 for left-eye lights among the first lights (451, 465, 466) and an optical driver 1-2 for right-eye lights among the first lights (451, 465, 466).

According to an embodiment, the optical driver 1-1 and the optical driver 1-2 may operate in a master and slave form and communicate with the processor (120, 410, 420) through inter-integrated circuit (I2C) communication.

According to an embodiment, when executed by the processor (120, 410, 420), the instructions may cause the processor (120, 410, 420) further to input a third signal (635) related to exposure of the second cameras (280a, 280b, 280c, 325, 326, 327, 473, 721, 723, 725, 731, 733, 736) as a second trigger signal corresponding to a second optical driver (483, 770, 760) for the second lights (471, 485a, 485b, 485c).

According to an embodiment, the second cameras (280a, 280b, 280c, 325, 326, 327, 473, 721, 723, 725, 731, 733, 736) may include a secondary camera 2-1 (731), a secondary camera 2-2 (733), and a secondary camera 2-3 (736). The secondary camera 2-1 (731) may capture an image of a left side of a face of the user, the secondary camera 2-2 (733) may capture an image of a enter of the face of the user, and the secondary camera 2-3 (736) may capture an image of a right side of the face of the user.

According to an embodiment, when executed by the processor (120, 410, 420), the instructions may cause the processor (120, 410, 420) further to input third signals (635) related to respective exposures of the secondary camera 2-1 (731) and the secondary camera 2-2 (733) among the second cameras (280a, 280b, 280c, 325, 326, 327, 473, 721, 723, 725, 731, 733, 736) as a second trigger signal corresponding to a second optical driver (483, 770, 760) for the second lights (471, 485a, 485b, 485c).

According to an embodiment, a wearable electronic device (200, 300, 400, 700, 701, 900) may include at least one processor (120, 410, 420), memory (130, 430, 440) storing instructions to be executed by the processor (120, 410, 420), a first tracking device (450, 460, 710, 740, 910) including first infrared (IR) lights configured to generate images reflected on a left eye and a right eye of a user wearing the wearable electronic device (200, 300, 400, 700, 701, 900), a first primary camera (461, 713, 721) configured to track the reflected images and the left eye, and a first secondary camera (462, 716, 723, 725) configured to track the right eye, and a second tracking device (470, 480, 730, 720, 930) including second IR lights configured to reflect light on a face of the user and second secondary cameras (481, 731, 733, 736, 741, 743) configured to recognize a facial expression of the user by the second IR lights. When executed by the processor (120, 410, 420), the instructions may cause the processor (120, 410, 420) to control the first primary camera (461, 713, 721) to generate a first signal (621) related to exposure of the first primary camera (461, 713, 721) at a first exposure time of the first primary camera (461, 713, 721), and input the first signal (621) as a signal notifying the second secondary cameras (481, 731, 733, 736, 741, 743) of start of a frame.

According to an embodiment, when executed by the processor (120, 410, 420), the instructions may cause the processor (120, 410, 420) to control the first primary camera (461, 713, 721) to adjust a generation time of the first signal (621) such that the first exposure time of the first primary camera (461, 713, 721) and a second exposure time of the second cameras (280a, 280b, 280c, 325, 326, 327, 473, 721, 723, 725, 731, 733, 736) do not overlap each other.

According to an embodiment, the second secondary cameras (721, 723, 725, 731, 733, 736) may include a secondary camera 2-1 (731), a secondary camera 2-2 (733), and a secondary camera 2-3 (736). The secondary camera 2-1 (731) may capture an image of a left side of the face of the user, the secondary camera 2-2 (733) may capture an image of a center of the face of the user, and the secondary camera 2-3 (736) may capture an image of a right side of the face of the user.

According to an embodiment, the wearable electronic device (200, 300, 400, 700, 701, 900) may further include at least one of an optical driver 1-1 configured to control left-eye lights among the first IR lights according to a second signal related to exposure of the first secondary camera (462, 716, 723, 725), an optical driver 1-2 configured to control right-eye lights among the first IR lights according to the second signal, or a second optical driver (483, 770, 760) configured to control the second IR lights according to a third signal (635) related to exposure of the second secondary cameras (481, 731, 733, 736, 741, 743).

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
one or more processors;
memory communicatively coupled to the one or more processors;
a first tracking device comprising first lights corresponding to a first area of a user wearing the wearable electronic device and first cameras corresponding to the first area; and
a second tracking device comprising second lights corresponding to a second area of the user and second cameras corresponding to the second area,
wherein the memory store one or more computer programs including computer-executable instructions that, when executed by the one or more processors, cause the wearable electronic device to:
control a first primary camera among the first cameras to generate a first signal related to exposure of the first primary camera and input the first signal as a signal notifying the second cameras of start of a frame.

2. The wearable electronic device of claim 1, wherein, for inputting the first signal as the signal notifying the second cameras of the start of the frame, the one or more computer programs further comprise computer-executable instructions that, when executed by the one or more processors, cause the wearable electronic device to:
control the first primary camera to generate the first signal at a first exposure time of the first primary camera and input the first signal as the signal notifying the second cameras of the start of the frame.

3. The wearable electronic device of claim 2, wherein, for inputting the first signal as the signal notifying the second cameras of the start of the frame, the one or more computer programs further comprise computer-executable instructions that, when executed by the one or more processors, cause the wearable electronic device to:
control the first primary camera to adjust a generation time of the first signal such that the first exposure time of the first primary camera and a second exposure time of the second cameras do not overlap each other.

4. The wearable electronic device of claim 3, wherein, for adjusting of the generation time of the first signal, the one or more computer programs further comprise computer-executable instructions that, when executed by the one or more processors, cause the wearable electronic device to:
control the first primary camera to adjust the generation time of the first signal such that an interval between the first exposure time and the second exposure time decreases in proportion to a transmission time for which the first primary camera transmits one data frame.

5. The wearable electronic device of claim 4, wherein, for adjusting of the generation time of the first signal, the one or more computer programs further comprise computer-executable instructions that, when executed by the one or more processors, cause the wearable electronic device to:
control the first primary camera to adjust the generation time of the first signal such that the second exposure time is less than or equal to a value obtained by subtracting the first exposure time from the transmission time of one data frame transmitted by the first primary camera.

6. The wearable electronic device of claim 1,
wherein the first area corresponds to a left eye of the user and a right eye of the user, and
wherein the first tracking device comprises:
the first lights configured to generate images reflected on the left eye and the right eye of the user wearing the wearable electronic device;
the first primary camera configured to track the images reflected on the left eye of the user and the left eye of the user; and
a first secondary camera configured to track the images reflected on the right eye of the user and the right eye of the user.

7. The wearable electronic device of claim 1,
wherein the second area corresponds to a face of the user, and
wherein the second tracking device comprises:
the second lights configured to reflect light on the face of the user; and
the second cameras configured to recognize a facial expression of the user by the second lights.

8. The wearable electronic device of claim 1, wherein the first cameras are synchronized with each other.

9. The wearable electronic device of claim 1, wherein the second cameras are synchronized with each other.

10. The wearable electronic device of claim 1, wherein the first tracking device and the second tracking device operate with a constant delay within a same cycle.

11. The wearable electronic device of claim 1, wherein the one or more computer programs further comprise computer-executable instructions that, when executed by the one or more processors, cause the wearable electronic device to:
input a signal notifying start of a frame output from the first primary camera as a signal notifying a first secondary camera among the first cameras of the start of the frame.

12. The wearable electronic device of claim 1, wherein the one or more computer programs further comprise computer-executable instructions that, when executed by the one or more processors, cause the wearable electronic device to:
input a second signal related to exposure of a first secondary camera among the first cameras as a first trigger signal corresponding to an optical driver 1-1 for left-eye lights among the first lights and an optical driver 1-2 for right-eye lights among the first lights.

13. The wearable electronic device of claim 12, wherein the optical driver 1-1 and the optical driver 1-2 operate in a master and slave form and communicate with the one or more processors through inter-integrated circuit (I2C) communication.

14. The wearable electronic device of claim 1, wherein the one or more computer programs further comprise computer-executable instructions that, when executed by the one or more processors, cause the wearable electronic device to:
input a third signal related to exposure of the second cameras as a second trigger signal corresponding to a second optical driver for the second lights.

15. The wearable electronic device of claim 1,
wherein the second cameras comprise:
a secondary camera 2-1, a secondary camera 2-2, and a secondary camera 2-3,
wherein the secondary camera 2-1 is configured to capture an image of a left side of a face of the user,
wherein the secondary camera 2-2 is configured to capture an image of a enter of the face of the user, and
wherein the secondary camera 2-3 is configured to capture an image of a right side of the face of the user.

16. The wearable electronic device of claim 15, wherein the one or more computer programs further comprise computer-executable instructions that, when executed by the one or more processors, cause the wearable electronic device to:
input third signals related to respective exposures of the secondary camera 2-1 and the secondary camera 2-2 among the second cameras as a second trigger signal corresponding to a second optical driver for the second lights.

17. A wearable electronic device, comprising:
one or more processors;
memory communicatively coupled to the one or more processor;
a first tracking device comprising first infrared (IR) lights configured to generate images reflected on a left eye and a right eye of a user wearing the wearable electronic device, a first primary camera configured to track the reflected images and the left eye, and a first secondary camera configured to track the reflected images and the right eye; and
a second tracking device comprising second IR lights configured to reflect light on a face of the user and second secondary configured to recognize a facial expression of the user by the second IR lights,
wherein, the memory store one or more computer programs including computer-executable instructions that, when executed by the one or more processors, cause the wearable electronic device to:
control the first primary camera to generate a first signal related to exposure of the first primary camera at a first exposure time of the first primary camera, and input the first signal as a signal notifying the second secondary cameras of start of a frame.

18. The wearable electronic device of claim 17, wherein the memory store one or more computer programs including computer-executable instructions that, when executed by the one or more processors, cause the wearable electronic device to:
control the first primary camera to adjust a generation time of the first signal such that the first exposure time of the first primary camera and a second exposure time of the second cameras do not overlap each other.

19. The wearable electronic device of claim 17,
wherein the second secondary cameras comprise:
a secondary camera 2-1, a secondary camera 2-2, and a secondary camera 2-3,
wherein the secondary camera 2-1 is configured to capture an image of a left side of the face of the user,
wherein the secondary camera 2-2 is configured to capture an image of a center of the face of the user, and
wherein the secondary camera 2-3 is configured to capture an image of a right side of the face of the user.

20. The wearable electronic device of claim 17, further comprising at least one of:
an optical driver 1-1 configured to control left-eye lights among the first IR lights according to a second signal related to exposure of the first secondary camera;
an optical driver 1-2 configured to control right-eye lights among the first IR lights according to the second signal; or
a second optical driver configured to control the second IR lights according to a third signal related to exposure of the second secondary cameras.

21. The wearable electronic device of claim 17,
wherein the first cameras are synchronized with each other, and
wherein the second cameras are synchronized with each other.

22. The wearable electronic device of claim 17, wherein the first tracking device and the second tracking device operate with a constant delay within a same cycle.
